(19) United States
(12) Patent Application Publication
(10) Pub. No.: US 2009/0249340 A1
(43) Pub. Date: Oct. 1, 2009

(54) Managing the Progress of a Plurality of Tasks

(75) Inventors: Kazuhito Akiyama, Tokyo (JP); Shinsaku Kudomi, Yokohama-shi (JP)

Correspondence Address: IBM CORP (IBM AUSTIN IPLAW), C/O D'AMBROSIO & ASSOCIATES, P.L.L.C, 10260 WESTHEIMER ROAD, SUITE 465, HOUSTON, TX, 77042, US

(73) Assignee: International Business Machines Corporation, Armonk, NY (US)

(21) Appl. No.: 12/415,317

(22) Filed: Mar. 31, 2009

(30) Foreign Application Priority Data
Mar. 31, 2008 (JP) 2008-92668

(51) Int. Cl. G06F 9/46; G06F 12/00

(52) U.S. Cl. 718/100; 707/200; 707/102; 707/E17.044; 711/E12.001

(57) ABSTRACT

Computer systems, methods and computer program products for managing progress of a plurality of tasks associated with respective configuration items. The configuration items are included in a system defined by a digital design specification. In one embodiment of the invention, a computer system includes a repository for holding a data set representative of at least one predetermined attribute of a configuration item and a relation between the configuration item and another configuration item, data regarding tasks, and association data for associating the configuration item and at least one task; and a discovery unit for detecting data regarding the configuration item.

### PRIORITY

This application is based on and claims priority from Japanese Patent Application No. 2008-92668 filed on Mar. 31, 2008.

### BACKGROUND

Large-scale system development projects require a large number of people, sometimes hundreds of people, to work on the project at the same time. People from different companies and different divisions are frequently involved in these development projects. The work may be carried out at a plurality of work places, such as designated project rooms, individual companies, or client sites. Additionally, tens and hundreds of computers and peripheral devices are involved in the system development.

### SUMMARY

One or more embodiments of the invention provide computer systems, methods and computer program products for managing or tracking the progress during system development and/or maintenance. In one embodiment of the invention, a system administrator may infer information necessary for managing the progress of a system development or maintenance project from configuration items and the associated tasks.

One or more embodiments of the invention provide up-to-date information on developmental and maintenance projects by utilizing project management methodology. Application software may be used in project management. In addition, the WBS (Work Breakdown Structure) is used in the project management. The WBS divides works executed by a project team to achieve a project goal and to create necessary deliverables into hierarchical elements.

Configuration management is a process of recognizing configuration items (hereinafter, abbreviated as CI), or resources subject to information technology (“IT”) management, and maintaining, updating, confirming, and monitoring information regarding the configuration items. CI include system resources, including hardware and software, equipment necessary for providing the IT services, documents such as regulation books, work procedures, and configuration diagrams regarding an operation of the IT services, services such as maintenance information, processes, and human resources. In one embodiment of the invention, CI may be managed in an integrated fashion using a database called configuration management database (hereinafter, abbreviated as CMDB). The CMDB is a database that records at least one predetermined attribute of the configuration items and relations between the configuration items and other configuration items. The CMDB may automatically discover information regarding CI (also referred to as discovery or automatic detection) and may automatically update the information regarding the configuration items (also referred to as tracking).

International Business Machines Corporation (hereinafter, abbreviated as IBM) provides “Tivoli Change and Configuration Management Database” (hereinafter, referred as Tivoli CCMDB). In one embodiment of the invention, the CCMDB assists the construction of a CMDB and controlling an operation process based on the CMDB. In the Tivoli CCMDB, operation management software is implemented to execute discovery and tracking. The Tivoli CCMDB may identify over 300 kinds of configuration items in a distributed network environment, such as servers, clients, an operating system (OS), middleware (Web/AP/DBMS/LDAP), package software, management tools, network devices, and storage devices. The Tivoli CCMDB can automatically discover and update information regarding each configuration item, such as, for example, information regarding configurations of a computer, information regarding applications operating in each computer, information regarding configurations of a network attached storage (NAS) connected to each computer, and information regarding configurations of a storage area network (SAN) directly connected to a network.

In one embodiment of the invention, information regarding a relation between each configuration item and another configuration item is transferred to a GUI display tool, such as a Tivoli Application Dependency Discovery Manager (hereinafter, abbreviated as TADDM) console. The TADDM is one component of the CCMDB. The relation between each configuration item and another configuration item is visually displayed using individual blocks and links between the blocks.

In one embodiment of the invention, a computer system for managing progress of a plurality of tasks comprises a processor and a computer readable storage medium included in the processor. The computer readable storage medium has disposed within it a repository for holding one or more data sets representative of at least one predetermined attribute of a configuration item and a relation between the configuration item and another configuration item, and one or more data sets representative of the tasks and association data for associating the configuration item and at least one task. The computer system further comprises a discovery unit for detecting data associated with the configuration item. The one or more data sets and the association data are updated using the detected data. The one or more configuration items are included in a system defined by a digital design specification. The one or more data sets are created from data in the system defined by the digital design specification.

In one embodiment of the invention, the repository may be a CMDB. The configuration item, the relation between the configuration item and the other configuration item, the task, the relation between the task and the other task or the configuration item, and the association data can be implemented by an instance of static data or an instance of a class of Java (trademark of Sun Microsystems).

The system defined by the digital design specification may be under development or maintenance. The tasks may be related to the development or maintenance of the system defined by the design specification.

In one embodiment of the invention, the computer system may further include a display device for displaying a topology map that indicates information regarding at least one configuration item included in the system defined by the digital design specification, the relation between the configuration item and the other configuration item, and the task associated with the configuration item.

The display device displays may update information regarding the configuration item in response to a change in the at least one configuration item included in the system defined by the digital design specification or in the data regarding the configuration item.

The information regarding the task may be updated using imported data regarding the task. The display device displays the updated information regarding the task. The information regarding the task corresponds to at least one of information regarding a task progress rate or a task progress state, an amount of remaining work of the task, a task list, and an association between the task and another task, for example. The data regarding the task includes at least one of a task name, a task work period, a scheduled task work start date, a scheduled task work end date, an actual task work start date, an actual task work end date, a task restriction, a preceding task, and a following task.

The topology map further indicates a status related to the configuration item. In one embodiment, the status may be at least one of “complete”, “available”, “partially available”, “unavailable”, “not started”, and “trouble occurring”.

The attribute of the association data may correspond to at least one of a name of a host related to the task, a name of an application, and a port number of the application.

The computer system may further include an association data creating unit. The association data creating unit performs mapping between the data set regarding the configuration item and the data set regarding the task to create the association data.

The computer system may further include a detecting unit for detecting a relation between the tasks. The detecting unit detects the relation between the tasks using the association data of the configuration items. The computer system may schedule a new task in response to detection of the relation between the tasks.

In one or more embodiments of the invention, tasks include, but are not limited to, a task for system development and a task for maintenance. For example, the tasks may be managed by application software, such as a project management tool, e.g., the Microsoft (trademark) project and the RFM (RedHat Package Manager). The WBS (Work Breakdown Structure) is used in the project management. The WBS divides works executed by a project team to achieve a project goal and create necessary deliverables into hierarchical elements based on the element deliverables. The WBS breaks the project work into a work unit that is smaller and easier to handle and defines a work of the project in detail as the level lowers by one step. The lowest level of the WBS configuration item is called a work package. The work thereof is treated as a plan target, such as a schedule, a cost estimation, monitoring, and controlling.

In one or more embodiments of the invention, a design specification has the same meaning as a specification. The design specification is a document that specifies requirements, designs, operations, and other characteristics of systems, configuration items, products, results, or services in a complete, accurate, and verifiable method. An example of an embodiment of the design specification is a system specification for system development or system maintenance. In the design specification, the content of the design specification, particularly, information regarding the configuration items of the system, is digitalized. Herein, the design specification is referred to as a digital design specification.

In one or more embodiments of the invention, a system under development includes, for example, a computer system distributed over a network and a controller system connected to a network including appliances. Configuration items of the computer system include, for example, computers including a client computer, a personal digital assistant (PDA), and a server computer, peripheral devices thereof, and application software including an operating system and middleware. The peripheral devices may be, for example, a router and a storage device. The configuration items may be digital appliances, such as a digital television, a digital recorder, and a digital music player. Furthermore, the configuration items may include people, such as a system administrator and a user.

In one or more embodiments of the invention, the configuration items of the system under maintenance are the same as the above-described configuration items of the system under development.

Implementations of the computer system discussed above may include a method, a computer-implemented method or a computer program product. The details of one or more embodiments of the invention are set forth in the accompanying drawings and the description below. Other features of the invention will be apparent from the description and drawings, and from the claims. It should be understood that the scope of the present invention should not be limited to the embodiments shown herein. In addition, the same numerals represent the same objects in the drawings given below unless otherwise noted.

The foregoing is a summary and thus contains, by necessity, simplifications, generalizations, and omissions of detail. Those skilled in the art will appreciate that the summary is illustrative only and is not intended to be in any way limiting.

### BRIEF DESCRIPTION OF THE DRAWINGS

FIG. 1A shows an example of a computer system including a CMDB.

FIG. 1B shows an overview of a TADDM.

FIG. 2A shows creation of CI instances of a device A and a device B and relation instances thereof.

FIG. 2B shows a data model, a discovery instance, a CI instance, and a relation model.

FIG. 2C shows an example of a configuration information management screen in a CMDB.

FIG. 2D shows an example of a transaction dependency in a CMDB.

FIG. 2F shows a schematic diagram of a WBS.

FIG. 2F shows an example of work scheduling and progress management in a WBS.

FIG. 3 shows a current system development project.

FIG. 4A shows a first embodiment (A) and a second embodiment (B) of the present invention.

FIG. 4B shows an association between a system configuration CI and a task according to an embodiment of the present invention.

FIG. 5 shows a flow of task progress management according to an embodiment of the present invention.

FIG. 6 schematically shows an association according to an embodiment of the present invention.

FIG. 7 shows an example of display of a system configuration CI and an association between the system configuration CI and another configuration CI according to an embodiment of the present invention.

FIG. 8A shows a display example of a list of tasks associated with a system configuration CI according to an embodiment of the present invention.

FIG. 8B shows a display example of a progress rate according to an embodiment of the present invention.

FIG. 9 shows a display example of occurrence of a trouble according to an embodiment of the present invention.

FIG. 10 shows a display example of a status associated with a system configuration CI according to an embodiment of the present invention.

FIG. 11 shows a display example of a system configuration CI and information regarding a task according to an embodiment of the present invention.

FIG. 12 shows a display example of an association between a task and another task according to an embodiment of the present invention.

FIG. 13 shows automatic detection of a relation between tasks according to an embodiment of the present invention.

FIG. 14 shows detection of a conflict between tasks according to an embodiment of the present invention.

FIG. 15 shows detection of a preceding task according to an embodiment of the present invention.

FIG. 16 shows detection of a task involving a change in a system according to an embodiment of the present invention.

FIG. 17 shows processing of task information using information regarding a system configuration CI according to an embodiment of the present invention.

FIG. 18 shows display of a more detailed progress state from display of a progress state in a unit of subsystem according to an embodiment of the present invention.

### DETAILED DESCRIPTION

Exemplary computer systems, methods and computer program products for managing a plurality of tasks are described with reference to the accompanying drawings. The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention and the practical application, and to enable others of ordinary skill in the art to understand the invention for various embodiments with various modifications as are suited to the particular use contemplated.

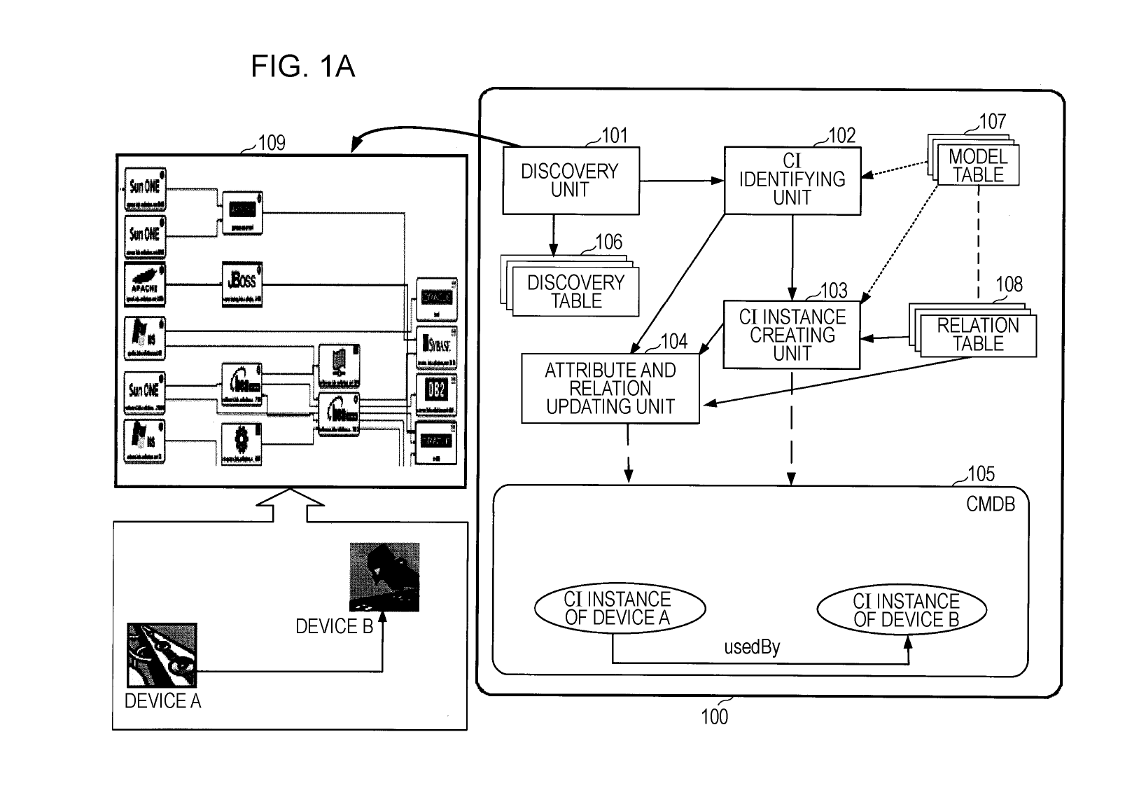

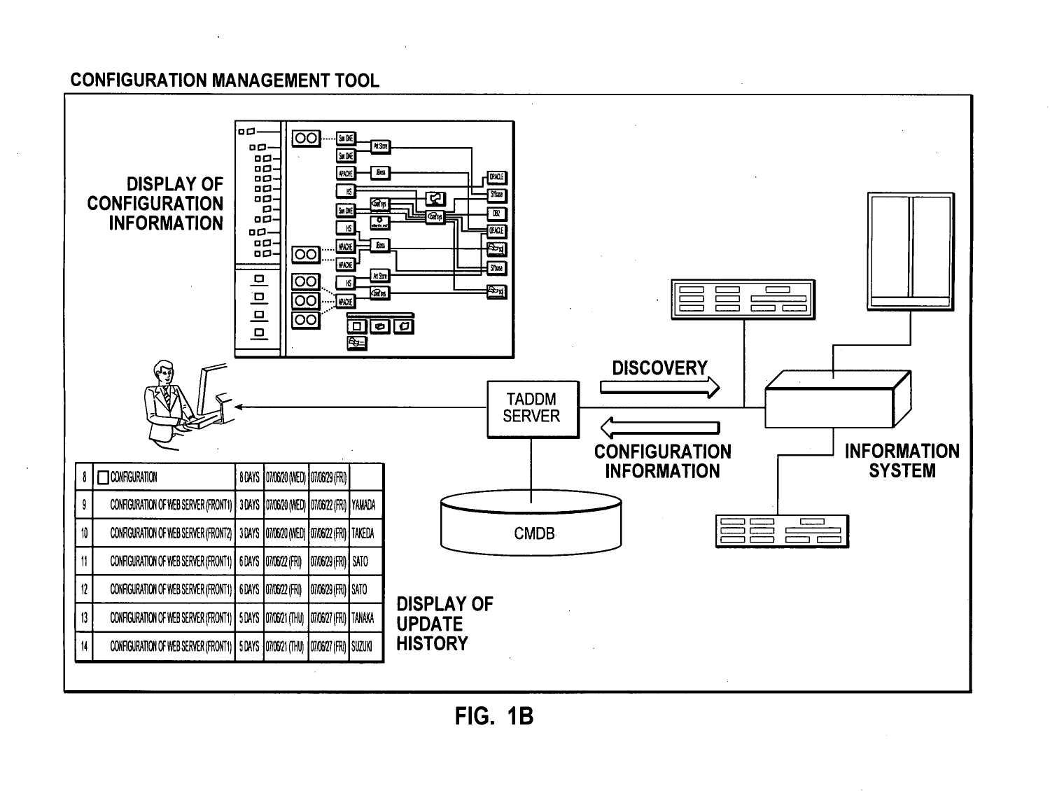

With general reference to the figures and with special reference now to FIG. 1A, a computer system (100) includes a CMDB for use in management of CIs (e.g., a Device A and a Device B). The computer system (100) includes a discovery unit (101), a CI identifying unit (102), a CI instance creating unit (103), an attribute and relation updating unit (104), and a CMDB (105). The discovery unit, the CI identifying unit, the CI instance crating unit, the attribute and relation updating unit, and the CMDB may be implemented in a single computer or may be implemented in a plurality of computers in a distributed manner. The computer system (100) further includes a discovery table (106), a model table (107), and a relation table (108). These tables may be implemented in a storage device of a single computer or may be implemented in storage devices of a plurality of computers in a distributed manner.

In one embodiment of the invention, information necessary for managing the progress of a system development or maintenance project may be obtained from the manner in which one or more configuration items are associated with corresponding tasks. In one embodiment of the invention, configuration items may be associated with a digital design specification of a system under development or maintenance. A repository may hold, for each configuration item, a set of data indicating at least one predetermined attribute of the configuration item and a relation between the configuration item and another configuration item. The repository may be, for example, a CMDB. The configuration items and the relation between the configuration items and other configuration items can be implemented by, for example, an instance of static data or an instance of a class of Java (trademark of Sun Microsystems). In one embodiment, the repository may comprise a CMDB recording unit that records the CMDB.

In one embodiment of the invention, a computer system may display information regarding tasks, such as, for example, a task progress rate or a progress state, an amount of remaining work to complete the task, a task list, and an association between the task and another task in association with configuration items included in a system defined by a digital design specification. Furthermore, in one or more embodiments of the invention, the computer system may automatically detect a relation between tasks, e.g., conflict between tasks and a preceding task, depending on the configuration items.

The following terms regarding the CMDB are used in the description that follows. The definitions are provided for clarity of understanding.

Configuration Item (CI): A CI is a basic unit of an IT system under the control of a configuration management system. The CI may include, for example, system resources including hardware and software, equipment necessary for providing IT services, documents such as regulation books, work procedures, and configuration diagrams regarding an operation of the IT services, services such as maintenance information, processes, and human resources.

Configuration Management Database (CMDB): A CMDB is a database that records at least one predetermined attribute of each CI and a relation between the CI and another CI. Although the CMDB is conceptually a database, the CMDB may be physically a database system or a spreadsheet of spreadsheet software. The CMDB may help an administrator to understand the relation between CIs.

Configuration Item Instance (CI Instance): A CI instance is data corresponding to a CI. Each CI instance is represented in a CMDB as an instance of a data model. In one embodiment of the invention, the CI is an instance of static data or an instance of a class of Java (trademark of Sun Microsystems). The implemented Java class instances may be stored in the CMDB with a mechanism for permanently storing the Java class instances in a hard disk, which is called, for example. Java data objects (JDO). Even if the computer system is temporarily powered off, the created Java class instances are not deleted. When the computer system is powered on next time, the Java class instances are read out from a storage device, e.g. the hard disk, are loaded to a main memory, and serve as Java class instances that can be updated or deleted by a Java program.

Data Model: A data model is a schema for defining a CI and is an information model that provides a consistent definition regarding managed CIs and a relation between the CIs. In one embodiment, the data model may define a predetermined attribute of the CI and a relation between the CI and another CI (such as manufacturing equipment and a process). A “Common Data Model” (“CDM”) is an example of a data model advocated by IBM. In one embodiment of the invention, the implementation of the CDM is carried out based on a unified modeling language (UML).

Attribute: An attribute identifies an individual CI and describes the CI to manage it. The attribute comprises a name of a CI (a general name of a CI, e.g., a server, a client, and firewall), a serial number (ID) (a number, such as a serial number, for individually identifying a specific entity of a CI), a category (a category of a CI, e.g., hardware, software, and a document), a type (description of an CI that describes classification of the category in detail), a model number (a model number of a CI named by a provider), a warranty period (warranty period decided by a provider of the CI), a version number (a version number of the CI), a location (a place where an CI exists, such as, for example, a place where a PC is placed, a library of software, a place where a medium is stored, a site providing a service), a responsible person (a name of a person responsible for management of the CI), a responsibility start date (a date when the responsible person is responsible for the CI), a provider (a developer or a provider of the CI), a license (a license number or the number of licenses), a provided date (a date when the CI is provided to an organization), a received date (a date when the CI is received by the organization), a usage start date (a date when the use of the CI is started), a status of a CI (a current status, e.g., operating, testing, and out of order, or a future status, e.g., a planned CI status), and a status of an CI instance (active or inactive of the CI instance).

Relation: A relation represents the connection between one or more CIs. The relation can be defined by a data model as in the case of the CI. Examples of the relation are “assigns”, “canConnect”, “canUse”, “connectAt”, “connects”, “controls”, “deployedOn”, “Located”, “Managed”, “Owned”, “provides”, “runAt”, “uses”, and “usedBy”.

Transaction dependency: A transaction dependency is a type of CI relation. The transaction dependency indicates that a transaction exists between two applications.

In one embodiment of the invention, as shown in FIG. 1A, a TADDM console screen (109) may show a connection relation between CIs and other CIs. The connection relation between the CIs shown in FIG. 1 is only for exemplary purposes, and all the connection relations between the CIs to be managed by the computer system (100) are not displayed.

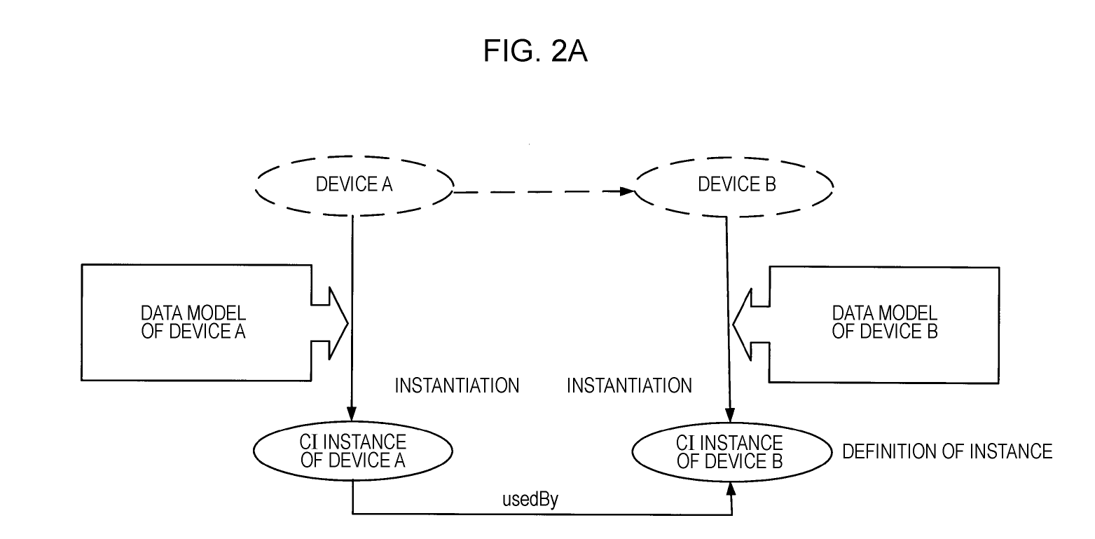

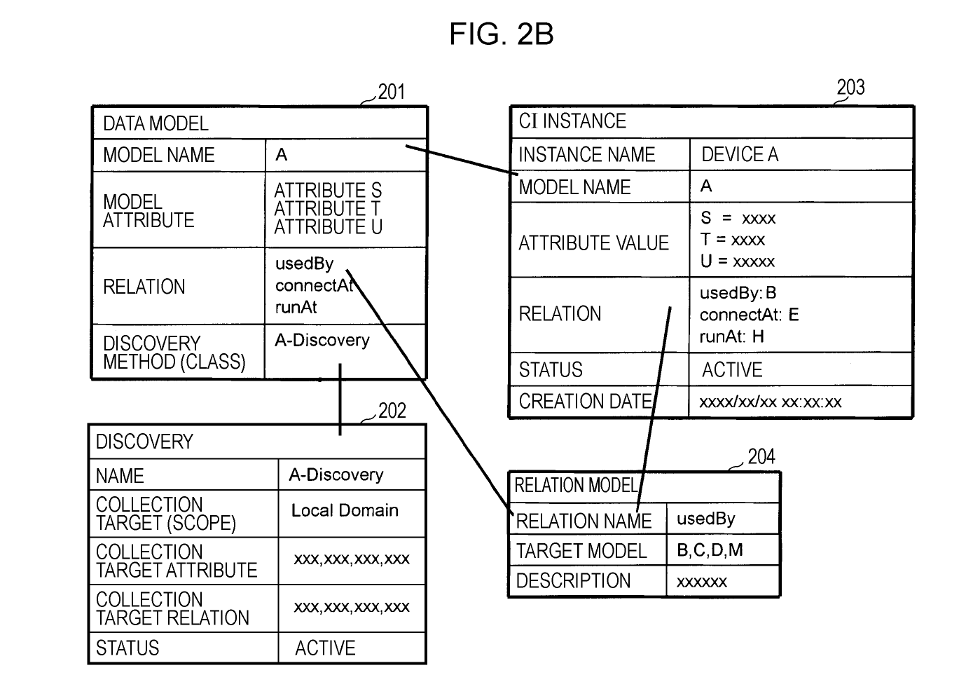

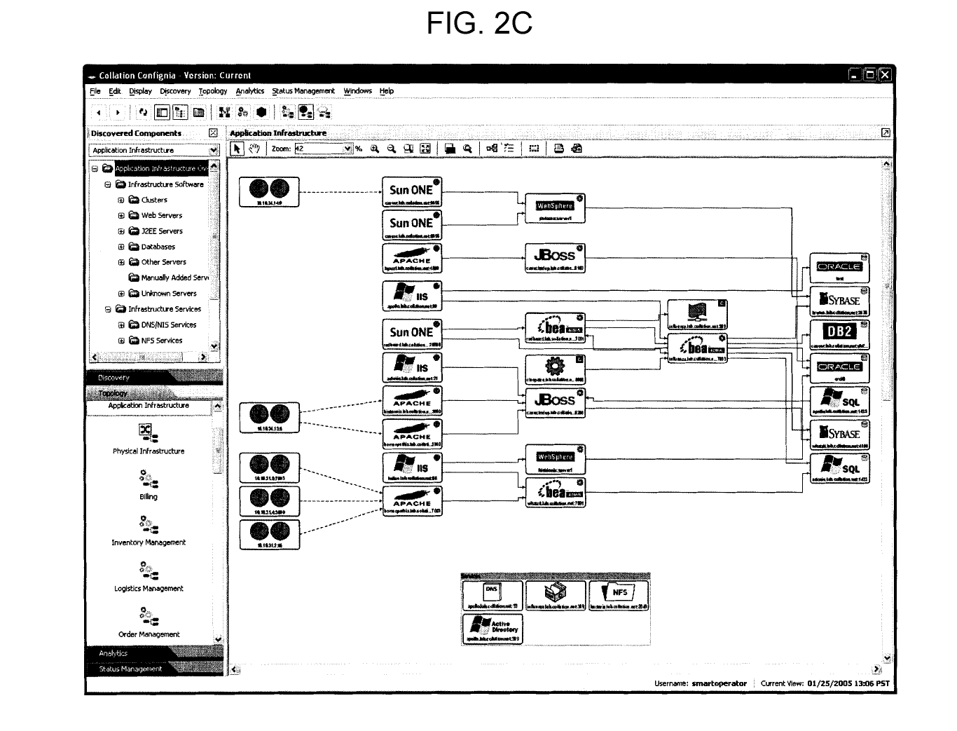

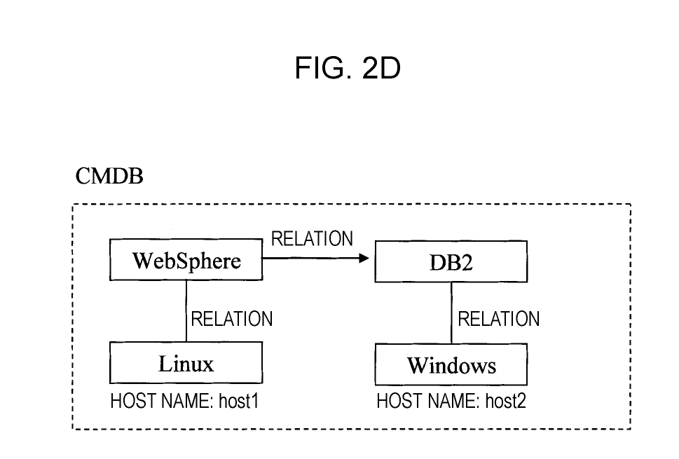

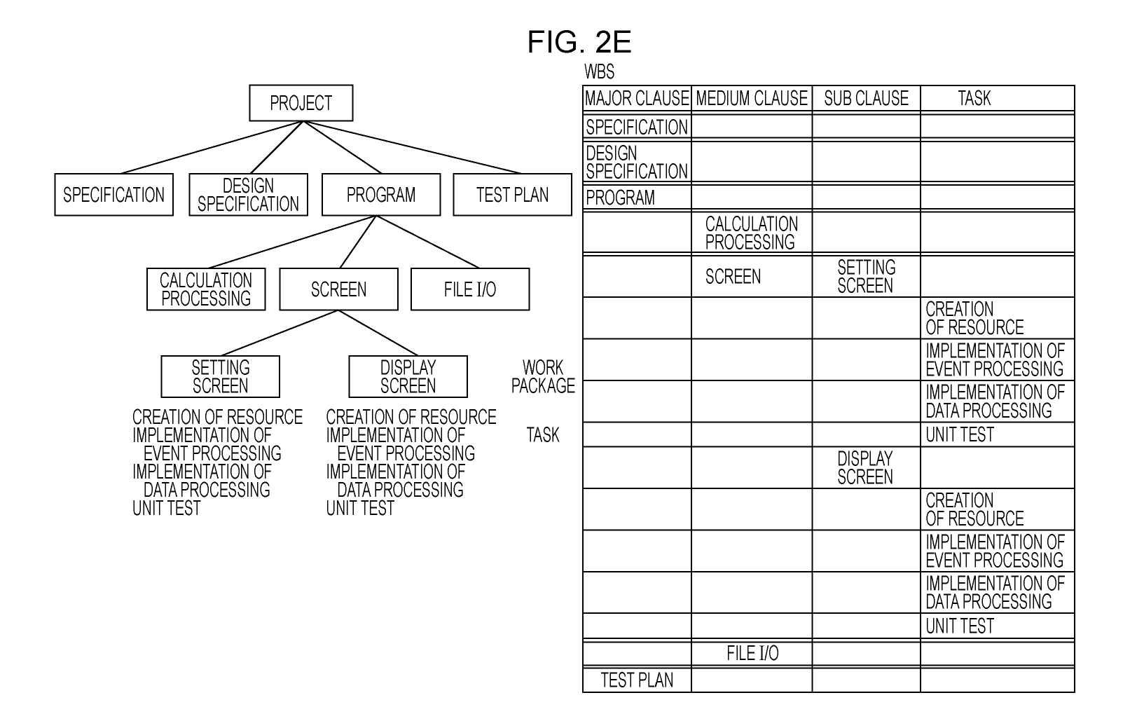

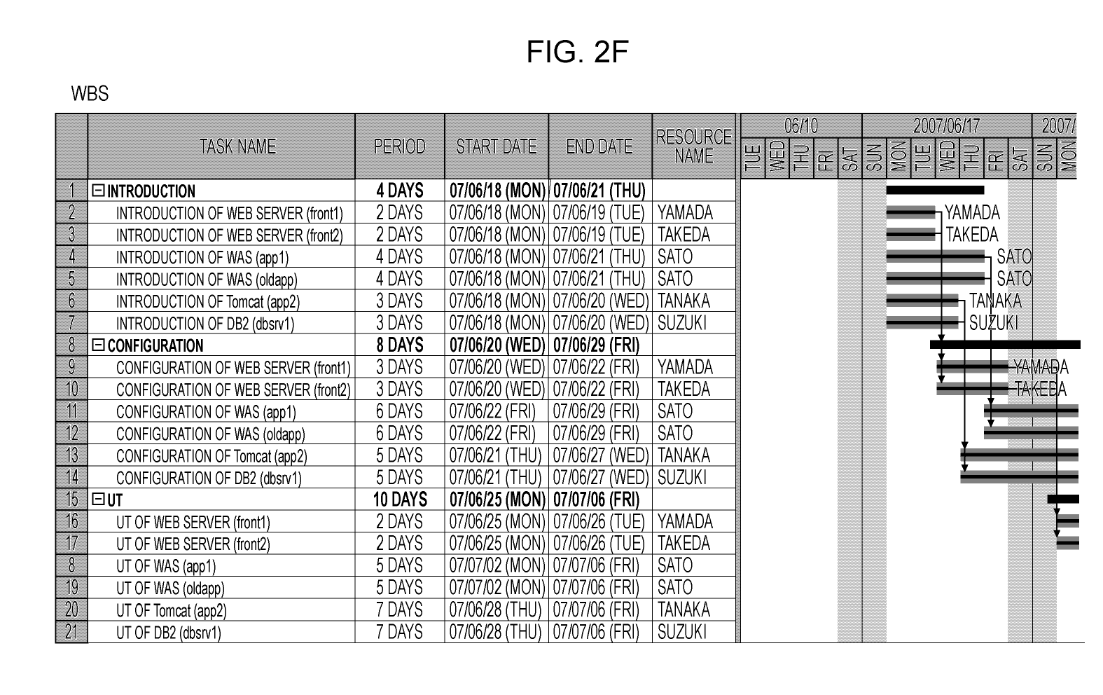

The discovery unit (101) executes detection or discovery of information regarding a CI to be managed by the CMDB. The computer system (100) may have a plurality of discovery units (101). Preferably, the management target is connected to the computer system (100) via a network. The network may be wired or wireless. An administrator of the computer system (100) can set the detection target freely. In one embodiment of the invention, a detection range can be specified using a domain name, an IP address, a MAC address, a device identifier, a database name, or combinations thereof. When the CI to be managed is, for example, an industrial device, the information regarding the industrial device is detected. The detected information may be information regarding a new CI or a value of an updated attribute or relation regarding an existing CI. The new CI is a CI that is detected by the discovery unit (101) but is not registered in the CMDB (105). The existing CI is a CI whose CI instance has been already registered in the CMDB (105). The discovery unit (101) detects the information regarding the CI according to discovery information (e.g., A-Discovery) (202 of FIG. 2B) stored in the discovery table (106). The discovery information to be used is specified in a discovery method of a data model (201 of FIG. 2B). The discovery unit (101) transfers the detected information regarding the CI to the CI identifying unit (102).

The CI identifying unit (102) receives the information regarding the CI from the discovery unit (101) and performs processing on the detection result. The CI identifying unit (102) determines whether the information regarding the CI is the information regarding the new CI or the value of the updated attribute or relation of the existing CI with reference to the CMDB (105). In one embodiment of the invention, the determination may be performed by comparing an instance name of the CI stored in the CMDB with the information regarding the CI. Upon identifying that the information regarding the CI is the information regarding the new CI, the CI identifying unit (102) may transfer the information to the CI instance creating unit (103). If upon identifying that the information regarding the CI is the value of the updated attribute or relation of the existing CI, the CI identifying unit (102) may transfer the information to the attribute and relation updating unit (104).

The CI instance creating unit (103) creates a set of data indicating a predetermined attribute of the CI and a relation between the CI and another CI from the information regarding the CI according to a data model (201 of FIG. 2B) stored in the model table (107) and a relation model (204 of FIG. 2B) stored in the relation table (108). The set of data is instantiated on the basis of the information regarding the CI detected by the discovery unit (101) or manually input information regarding the CI (see FIG. 2A). The set of data can be implemented by an instance of static data and an instance of a class of Java (trademark of Sun Microsystems), for example. An example of the set of data is a CI instance. FIG. 2B shows an example of a CI instance (203). The set of data is stored in the CMDB (105). In addition, the set of data may include an attribute and a relation in the CI instance (see 203) or may have an attribute in the CI instance and a relation instance may be stored in the CMDB (105) separately from the CT instance. In the latter case, the CI instance has linking for identifying an associated relation instance.

The attribute and relation updating unit (104) realizes tracking in cooperation with the discovery unit (101). The attribute and relation updating unit (104) reflects the value of the updated attribute or relation of the CI in the CI instance of the CI stored in the CMDB. More specifically, the attribute and relation updating unit (104) updates the value of the attribute or relation of the CI instance of the CI. The update is performed by replacing the values with the information regarding the CI detected by the discovery unit (101). Regarding the replacement, all of values of the attribute or relation of the CI instance may be replaced with the information regarding the CI detected by the discovery unit (101) or only different values may be replaced. The CMDB (105) records the CI instances ((203) of FIG. 2B) of CIs.

The discovery table (106) stores the discovery information (202 of FIG. 2B). The discovery information may be used when the discovery unit (101) detects the information regarding the CI. The discovery information (202 of FIG. 2B) may be implemented by an instance of static data or an instance of a class of Java (trademark of Sun Microsystems), for example. The discovery information is also referred to as a discovery policy. The discovery information (202 of FIG. 2B) includes a range searched by the discovery unit (101), namely, a collection target (scope) that is a CI search range, an attribute to be collected, and a relation to be collected (202 of FIG. 2B). The collection target may be specified by using, for example, a subnet IP address, a range of IP addresses, individual IP addresses, MAC addresses, device identifiers, host names, database names, or combinations thereof. In another embodiment, the collection target may be specified as a schedule management database (not shown) connected to the computer system (100) via a network. The schedule management database stores, for example, data regarding process management using devices. In still another embodiment, the collection target may be specified as a database (not shown) storing a batch processing definition file. When the collection target is the database storing the batch processing definition file, the discovery unit (101) loads the content of the batch processing definition file to perform detection. The batch processing definition file stores, for example, data describing the order of using devices.

The model table (107) stores the data model (201 of FIG. 2B). The data model is used when the CI instance creating unit (103) creates a set of data indicating a predetermined attribute of the CI and a relation between the CI and another CI.

The relation table (108) stores the relation model (204 of FIG. 2B). The relation model is used when the CI instance creating unit (103) creates a set of data indicating a predetermined attribute of the CI and the relation between the CI and another CI.

FIG. 1A shows that the discovery unit (101) detects information regarding a management target device connected to the computer system (100) via a network. As a result, the discovery unit (101) detects information regarding a device A and information regarding a device B that uses the device A. The CI identifying unit (102) then determines whether the information is information regarding a new CI with reference to the CMDB (105). According to the determination result, the CI instance creating unit (103) may create a CI instance of the device A, a CI instance of the device B, and an instance regarding a relation between these devices (usedBy). These instances may be stored in the CMDB (105).

FIG. 1B shows an overview of a configuration management tool. The configuration management tool has a function for automatically collecting configuration information (discovery), a function for graphically displaying the configuration information (topology), and a function for performing analysis of an updated history and configuration comparison (analytics). In one embodiment, a TADDM server may acquire configuration information regarding an information system using the ssh, the SNMP, or the WMI. The configuration information may be, for example, a kind of an operating system of each information system and a configuration thereof, and a kind of application and a configuration value thereof. The TADDM server stores the acquired information in the CMDB as a CI instance. The TADDM server sends configuration information and update history information to an administrator's computer on the basis of the CI instance stored in the CMDB. In one embodiment of the invention, an administrator's computer displays the configuration information and the update history using the information.

FIG. 2A shows creation of CI instances of CIs (e.g., the device A and the device B) and a relation (usedBy) instance of these devices. The CI instance of the device A may be created by the CI instance creating unit (103) based on the information regarding the device A detected by the discovery unit (101) using the data model of the device A. Similarly, the CI instance of the device B may be created by the CI instance creating unit (103) based on the information regarding the device B detected by the discovery unit (101) using the data model of the device B. The data models of the device A and the device B may be stored in the model table (107 of FIG. 1A). The instance regarding the relation between the CIs, i.e., the instance regarding a relation (usedBy) between the device A and the device B, may be created by the CI instance creating unit (103) based on the information regarding the device A detected by the discovery unit (101) according to the relation model. The relation model is stored in the relation table (108).

As described above, FIG. 2A shows that the CI instance of the device B may be created using the data model of the device B. However, when devices instantiated using the data model of the device B are devices B1, B2, and B3. information regarding the devices B1, B2, and B3 may be instantiated using the data model and a CI instance of the device B1, a CI instance of the device B2, and a CI instance of the device B3 may be created. The CI instances of the devices B1, B2, and B3 may also be stored in the CMDB (105).

FIG. 2B shows the data model (201) stored in the model table (107 of FIG. 1A), the discovery instance (202) stored in the discovery table (106 of FIG. 1A), the CI instance (203) (of the device A) stored in the CMDB (105 of FIG. 1A), and the relation model (204) stored in the relation table (108 of FIG. 1A).

The data model (201) is a schema for defining a CI. The data model (201) comprises descriptions regarding “a model name” indicating a model of a CI, “a model attribute” indicating an attribute belonging to a CI specified by the model name, “a relation” that can be applied between the CI specified by the model name and another CI, and “a discovery method” identifying a discovery instance for use in detection of a CI specified by the model name. Although the model attributes may be defined according to attributes specified by a data model “CDM” for a configuration management database suggested by IBM, for example, the attributes are not limited to these. The CDM may define 2609 kinds of attributes. An administrator of the CMDB can specify the attribute of the data model (201) freely. Although the relation can be defined according to the relation specified by the CDM, the relation is not limited to these. The CDM may define 57 kinds of relations. The discovery method can be specified by a discovery instance name. In the case of FIG. 2B, the discovery instance name is A-Discovery.

The discovery instance (202) may include descriptions regarding “a name” of a discovery instance specified by a discovery method of the data model (201), “a collection target (scope)” of the management target (CI) to be collected by the discovery unit (101), “an attribute to be collected” and “a relation to be collected” of the management target (CI) to be collected by the discovery unit (101), and “a status” indicating whether the discovery instance is active or inactive.

The CI instance (203) may include descriptions regarding “an instance name” for specifying a CI corresponding to the instance, “a model name” indicating the data model used in creation of the instance, “an attribute value” of each attribute specified by the data model, “a relation” specified by the data model, “a status” indicating whether the instance is active or inactive, and “a creation date” when the CI instance is created. Preferably, the CI instance further includes a CI instance identifier unique to the CI instance. Although the CI instance identifier is not particularly specified as long as it can discriminate the CI instance from other CI instances, for example, a host name, a serial number, or a combination of other constant attribute values can be used as the identifier. The CI instance (203) of FIG. 2B indicates this instance is a CI instance of the device A; this instance is instantiated using the data model A; this instance includes S, T, and U as attributes and these attributes have values; this instance is used by the device B (usedBy:B), is connected to a device E (connectedAt:E), and is executed by a device H (runAt:H); this instance is active; and this instance includes data of the creation date.

The relation model (204) is a schema for defining a relation specified by the data model (201). The relation model (204) comprises descriptions regarding “a relation name” such as usedBy, “a target data model” for specifying a data model that is a target of the relation, and “a description” of the relation.

FIG. 2C shows an exemplary configuration information management screen of the CMDB using the TADDM. The screen is displayed as a GUI. In FIG. 2C, the configuration items may be applications. Relations between applications are represented as solid lines. The application names (trademarks of respective companies) displayed in the screen are illustrative only.

FIG. 2D shows an example of a transaction dependency in the CMDB. WebSphere and DB2 have a transaction dependency. Linux and WebSphere have a physical dependency that WebSphere is introduced to Linux. DB2 and Windows have a physical dependency that DB2 is introduced to Windows.

FIG. 2E shows a schematic diagram of the WBS. In the WBS, the entire project is divided into some major clauses. Each of the major clauses is further divided into some medium clauses and sub clauses. After the sufficient fractionation, specific works for each sub clause are listed. The sub clause corresponds to a work package, whereas the specific work corresponds to an activity or a task.

Referring to FIG. 2E, the major clause may include a specification of a project, a design specification of a project, a program, and a test plan. The medium clause may include calculation processing, a screen, and file I/O for the program of the major clause. The sub clause may include a setting screen and a display screen for the screen of the medium clause. A task may include creation of resources, implementation of event processing, implementation of data processing, and a unit test. Data regarding the task includes, but not limited to, at least one of a task name, a task work period, a scheduled task work start date, a scheduled task work end date, an actual task work start date, an actual task work end date, a task restriction, a preceding task, and a following task, for example.

A drawing on the left side of FIG. 2E is an example showing a tree diagram of the WBS. A drawing on the right side of FIG. 2E is an example showing the WBS in a table format.

FIG. 2F shows an example of work scheduling and progress management in the WBS. An example screen of the WBS shows a task name, a task work period, a task work start date, a task work end date, a resource name, a date, work scheduling, and progress management.

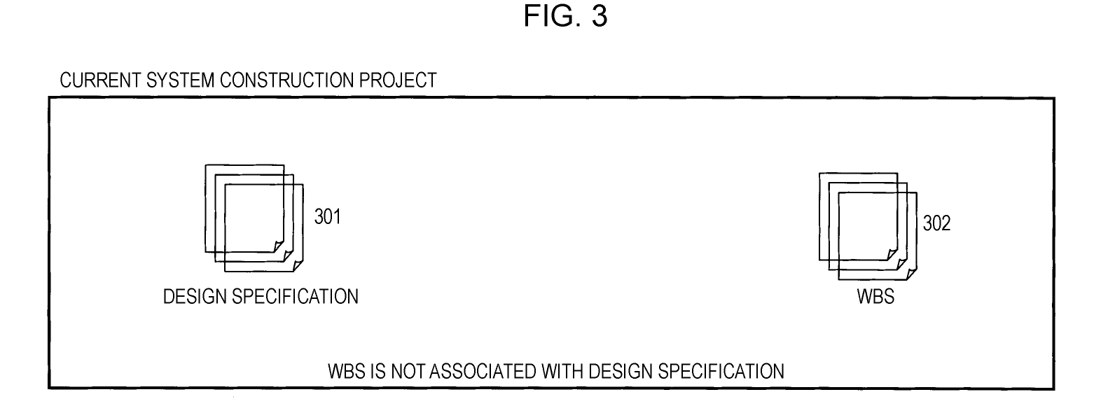

FIG. 3 shows a current system development project. Information regarding configuration items of a system defined by a design specification (301) is digitized (hereinafter, a digital design specification is simply referred to as a design specification). However, the design specification (301) may not be associated with the WBS (302). Accordingly, a system development administrator or a project administrator (hereinafter, simply referred to as an administrator) cannot perform progress management of tasks on the basis of the system configuration items defined by the design specification.

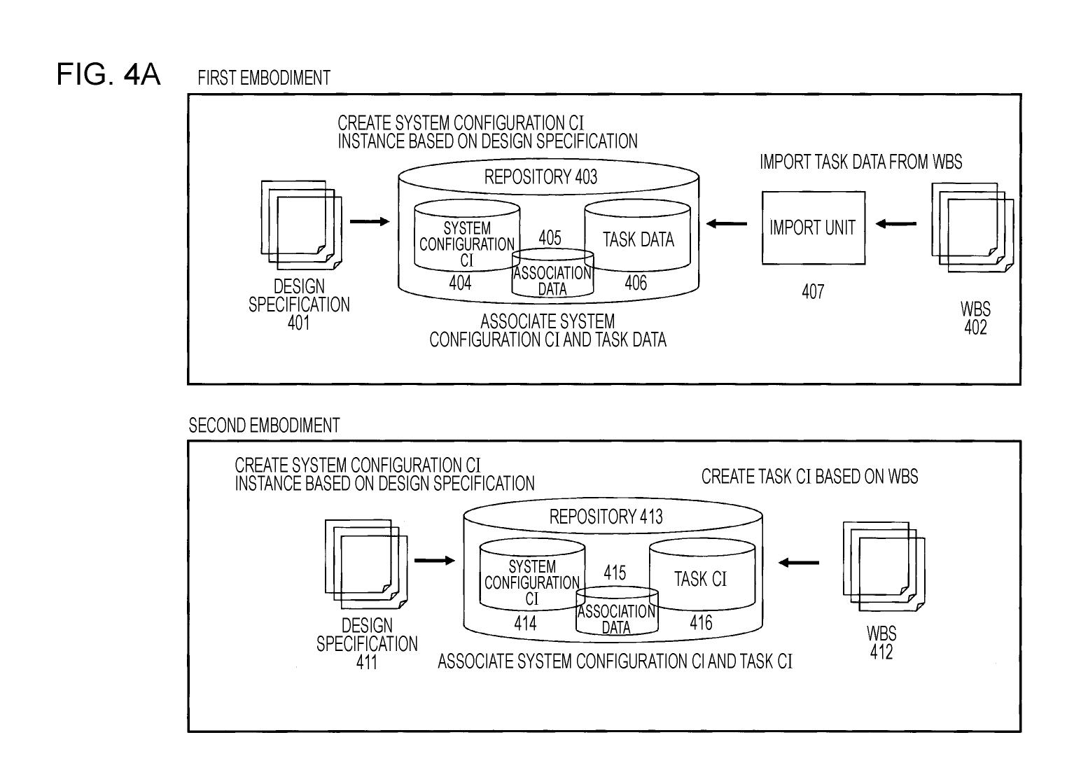

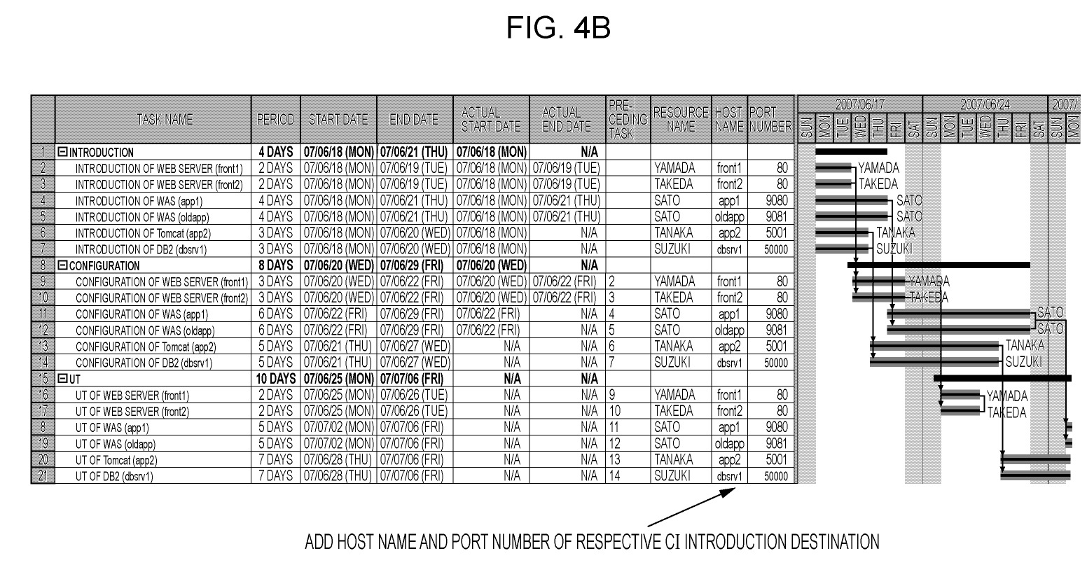

FIG. 4A shows an exemplary first embodiment and a second embodiment of the present invention. In the first embodiment, information associated with CI of a system defined by a design specification (401) is instantiated as system configuration CI instances. The system configuration CI instances (404) may be stored in a repository (403), e.g., a CMDB. The configuration items include configuration items that are defined in the design specification but do not actually exit and actually existing configuration items that correspond to the configuration items defined in the design specification. The repository (403) may be included in a computer system or connected to the computer system with a cable or via a network. The system configuration CI instance of the design specification (401) is a set of data indicating, for each configuration item of the system defined in the design specification (401), at least one predetermined attribute of the configuration item and a relation between the configuration item and another configuration item.

The computer system may import the data regarding the WBS (402) (hereinafter, simply referred to as task data) (406) through an import unit (407). The computer system may store the imported task data (406) in the repository (403). The computer system may associate the task data (406) and the system configuration CI instance (404) using association data (405). The system configuration CI instance (404) may be associated with the task data (406) through this association.

Accordingly, the administrator can know information necessary for progress management of a system development project from the manner in which the configuration item is associated with the task.

As shown in FIG. 4A, in a second embodiment, information regarding configuration items of a system defined by a design specification (411) may be stored in a repository (413), e.g., a CMDB, as system configuration CI instances as described above. The system configuration CI instance of the design specification (411) is a set of data indicating, for each configuration item of the system defined in the design specification (411), at least one predetermined attribute of the configuration item and a relation between the configuration item and another configuration item.

Data regarding WBS (412) may be instantiated as a task CI instance. The task CI instance (416) may be stored in the repository (413), e.g., the CMDB. The task CI instance (416) is a set of data indicating, for each task, at least one predetermined attribute of the task and a relation between the task and another task or a configuration item.

The computer system may associate the task CI instance (416) with the system configuration CI instance (414) using an association CI instance (415). The system configuration CI instance (414) may be associated with the task CI instance (416) using the association CI instance (415).

Accordingly, the administrator may infer information necessary for progress management of a system development project from the manner in which the configuration item is associated with the task.

FIG. 4B shows the association of a system configuration CI and a task according to an embodiment of the present invention. The association may be performed by adding an attribute that uniquely specifies the system configuration CI to task data of the task. The attribute may be, for example, a host name, an application name of an application, or a port number of the application. In one embodiment, the attribute is the host name and the port number of the application.

The attribute of the association CI instance may be an attribute that uniquely specifies the system configuration CI. Accordingly, the attribute may be a host name, an application name of an application, or a port number of the application. In one embodiment, the attribute is the host name and the port number of the application.

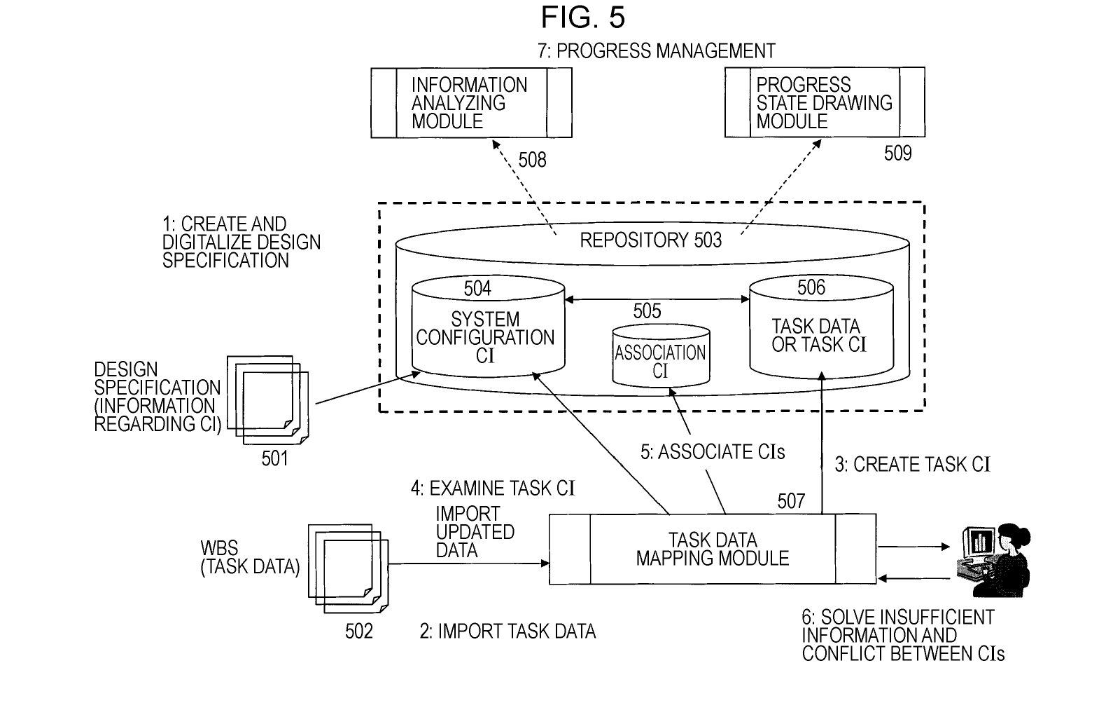

FIG. 5 shows a flow of progress management of tasks according to an embodiment of the present invention. Information regarding configuration items of a system defined by a design specification (501) is stored in a repository (503) as system configuration CI instances. One embodiment of the method for creating the CI instances is as described in the description regarding FIG. 1A, FIG. 2A, and FIG. 3A. To create the system configuration CI instance, the model table (107 of FIG. 1A) and the relation table (108 of FIG. 1A) are prepared. The data model (201 of FIG. 2B) for the system configuration CI instance may include (1) an attribute of the system configuration CI, and (2) a relation between the system configuration CI and another system configuration CI. The attribute of the system configuration CI may be, for example, a name of an introduction target host and a CI type. The CI type is a kind of CI. The kind of CI may include various kinds of applications including DB2, WebSphere, and AIX, various kinds of computer systems distributed over a network such as a client, a server, and a proxy server, kinds of digital appliances, and kinds of mobile devices including a PDA. The attribute of the CI differs depending on the CI types. In one embodiment, in the case of DB2, the attribute is a database name and an instance name. In another embodiment, in the case of AIX, the attribute is a host name and an IP address.

In one embodiment of the present invention, the import unit (407 of FIG. 4A) imports task data (406) from a WBS (502) and stores the data in the repository (503).

In another embodiment of the present invention, the task data imported from the WBS (502) may be stored in the repository (503) as a task CI instance. Each piece of the task data may be stored in the repository (503) as a task CI instance. Alternatively, a group of predetermined tasks may be created as one task CI instance on the basis of the model table (107 of FIG. 1A) for the task CI and stored in the repository (503). An embodiment of the method for creating the CI instance is as described in the description regarding FIG. 1A, FIG. 2A, and FIG. 3A. The model table (107 of FIG. 1B) and the relation table (108 of FIG. 1B) for use in creation of the task CI instance is prepared. The data model (201 of FIG. 2B) for the task CI instance includes (1) an attribute of the task CI, (2) a relation between task CIs, and (3) a relation between the system configuration CI and a task CI. The attribute of the task CI may be, for example, a name of a host where the work is performed, an application name, a name of a responsible person, a schedule, and a progress state. The relation between the task CIs may be, for example, a preceding task and a following task. The relation between the system configuration CI and the task CI may be, for example, the system configuration CI targeted by the task. The system configuration CI targeted by the task is a system configuration CI serving as a work target of the task. In one embodiment, in the case of a task of “introduction work of WebSphere to be introduced to a host1”, the system configuration CI serving as the work target of the task is “WebSphere to be introduced to the host1”. The CI instance creating unit (103 of FIG. 1A) sets the attribute and the relation of the tack CI, and creates the task CI instance according to the data model (201).

The attribute of the task may be verified to associate the system configuration CI instance (504) with the task data or the task CI (506). For the verification, the import unit (407 of FIG. 4A) may regularly import updated task data from the WBS. Alternatively, the import unit (407) may import the updated task data from the WBS in response to updating of the task data. Through the import, data of the task CI instance is updated.

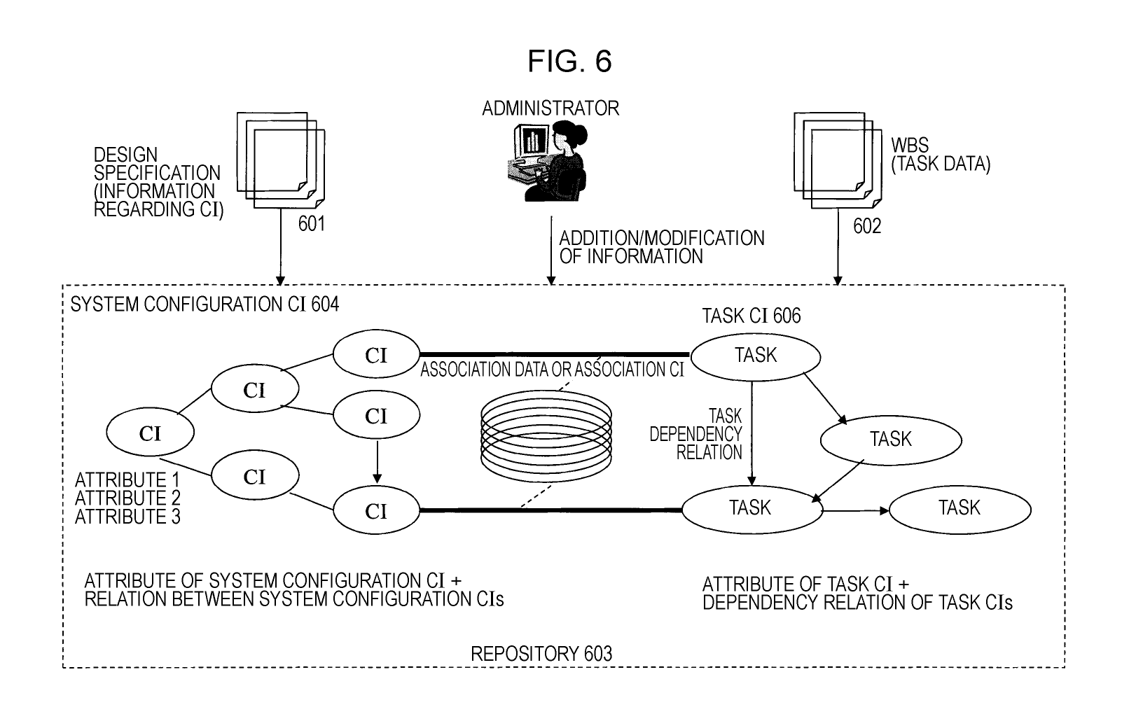

A task data mapping module (507) associates the system configuration CI instance with the task data or the task CI instance. More specifically, the task data mapping module (507) associates the task with an application that performs the work. The task data mapping module (507) stores the associated data in the repository (503) as association data or an association CI instance. The task data mapping module (507) also notifies the administrator of the association result. The administrator associates the task data or the task CI, which cannot be associated automatically, with the system configuration CI instance. An example of the task data or the task CI that cannot be associated automatically is those short of the attribute or those having duplicated attributes. Another example of the task data or the task CI that cannot be associated automatically is a case where there is a CI that corresponds to the system configuration CI but does not correspond to the task data or the task CI, which is an omission in the work. Another example, of the task data or the task CI whose attribute cannot be associated, is a case where there is a CI that corresponds to the task CI but does not correspond to the system configuration CI, which is an omission in the design. FIG. 6 schematically shows the association.

The administrator receives a notification regarding the mapping result regularly or at specified intervals from the task data mapping module (507). The administrator then solves the insufficient information and the conflict between the CIs.

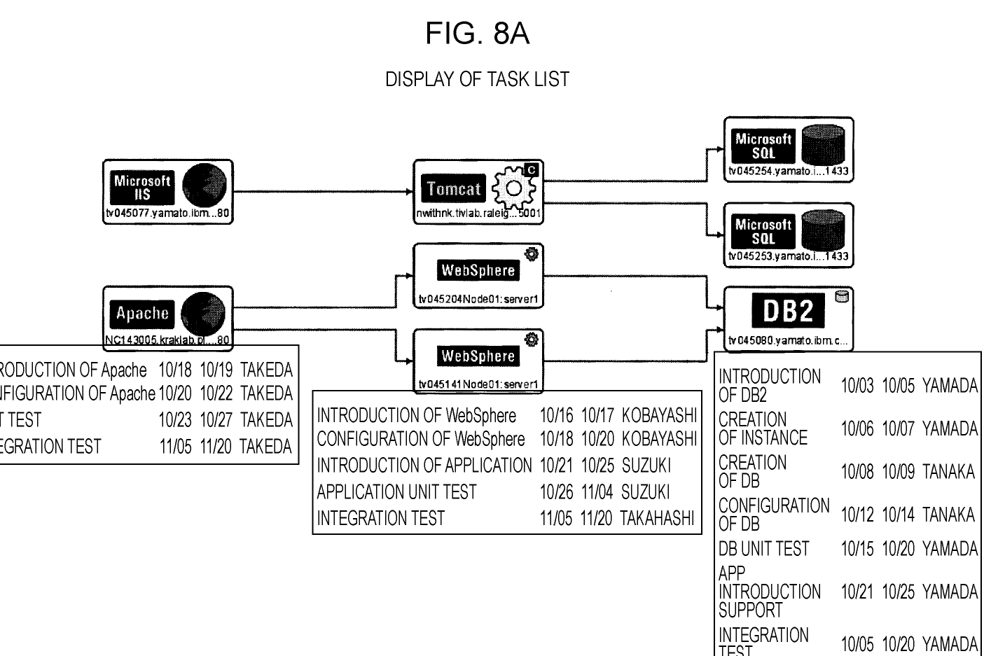

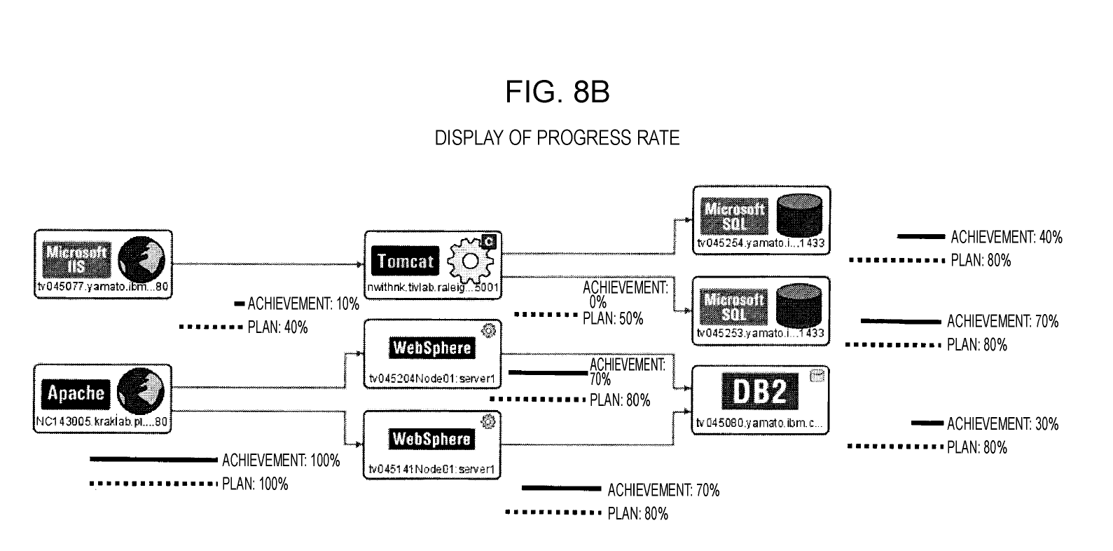

An information analyzing module and a progress state drawing module display a system configuration view, e.g., system configuration CI and information regarding tasks associated with the system configuration CI on the TADDM. The information regarding tasks associated with the system configuration CI may be, for example, a task progress rate or a progress state, an amount of remaining work of the task, a task list, and an association between the task and another task. FIG. 8A to FIG. 12 are examples of displays of the progress management information regarding tasks. The system configuration view is displayed while extending an existing display interface that displays a relation between the system configuration CIs. The progress management information may be, but not limited to, for example, a progress rate, a delay from the schedule, a progress in a unit of subsystem, a progress estimation, display of an affected range, and a simulation result of a task change.

The computer system according to an embodiment of the present invention automatically detects a relation between tasks using the attribute and relation of the system configuration CIs, particularly, the dependency of the system configuration CIs. The relation between the tasks may be, for example, a conflict between tasks or a preceding task. In addition, the computer system according to an embodiment of the present invention can automatically update the conflict of the tasks or the preceding task in response to updating of the progress status.

In addition, a computer system, according to an embodiment of the present invention, may automatically detect a task involving a change in a system defined by a digital design specification and in an existing system corresponding to the system. When the system configuration CI is changed, e.g., when a trouble occurs in the system, the computer system may display an involving task based on a work history describing a task progress history. The display allows an administrator to investigate a cause of the system change. The change in the system configuration CI can be realized utilizing a tracking function of the CMDB.

FIG. 6 schematically shows an association according to an embodiment of the present invention. A system configuration CI instance (604) has a set of data indicating an attribute of the system configuration CI and a relation between the system configuration CIs. The task data includes a set of data indicating an attribute of the task and a dependency between the tasks or between the task and the system configuration CI. Alternatively, the task CI instance has a set of data indicating the attribute of the task CI and the dependency between the task CIs. The system configuration CI instance (604) and the task data or the task CI instance may be associated by the association data or the association CI instance.

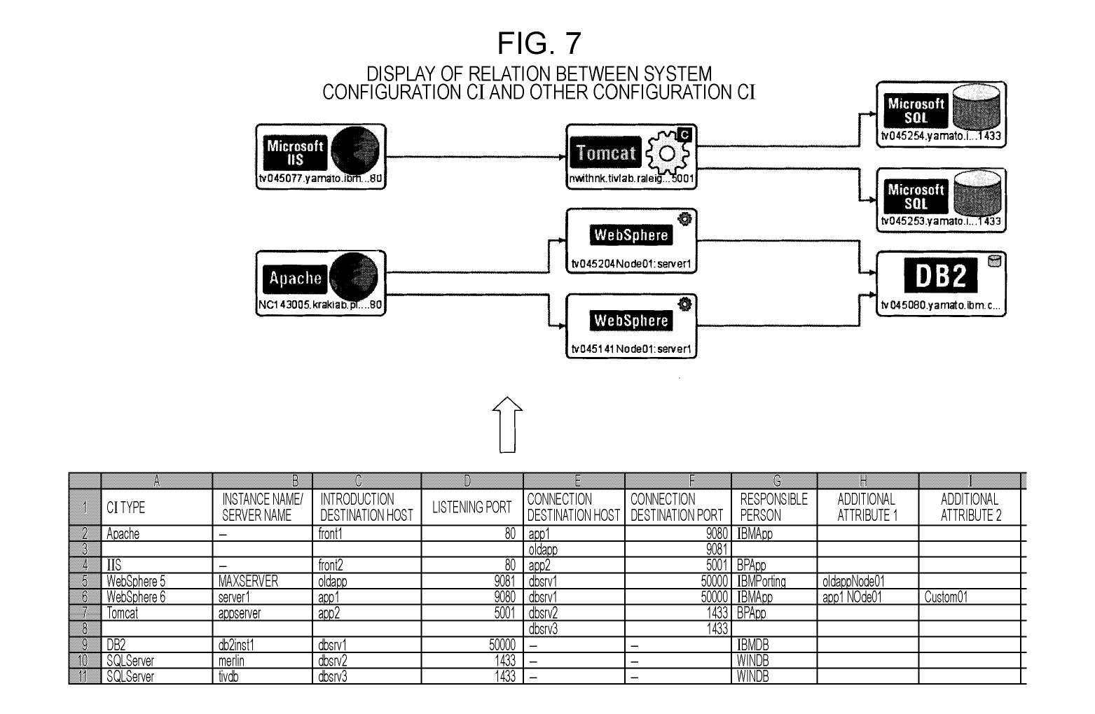

FIG. 7 shows an example of display of a system configuration CI (604) and an association between the system configuration CI and another system configuration CI according to an embodiment of the present invention. The association is displayed as a solid line between the system configurations.

The display is also referred to as a topology map. The topology map may be created from a table having attributes shown in FIG. 7, for example. The association between the system configuration CI and the other configuration CI may be performed using port numbers used by applications or application instances. In one embodiment, when WebSphere and DB2 are introduced to a server computer named host1. WebSphere performs Listening using the port number 9080 and DB2 performs Listening using the port number 50000. In such a case, if an application of a connection target host attempts to connect to WebSphere, the connection is established using “host1+9080”. Similarly, when the application of a connection target host attempts to connect to DB2, the connection is established using “host1+50000”. Accordingly, the other system and the server computer host1 are associated using the host name and the Listening port number of the application. An attribute “RESPONSIBLE PERSON” is a given attribute for filtering data. Attributes “ADDITIONAL ATTRIBUTE 1” and “ADDITIONAL ATTRIBUTE 2” are given attributes to be added to allow the administrator to easily identify the instance.

FIG. 8A shows an example of display of a list of tasks associated with system configuration CIs (604) according to an embodiment of the present invention. The computer system chronologically displays information regarding tasks associated with the system configuration CIs above or near the display of each system configuration CI in a system configuration diagram. The display includes, for example, a task name, a scheduled task work end date, an actual task work end date, and a name of person responsible for the task. The computer system may display the information regarding the task above all the system configuration CIs or may display the information regarding tasks above some of the system configuration CIs according to the filtering attribute.

FIG. 8B shows an example of display of a progress rate according to an embodiment of the present invention. An achieved progress rate and a planed progress rate are shown as a progress rate of a group of tasks associated with respective system configuration CIs. The achieved progress rate and the planned progress rate may be determined using the following equations:

Achieved Progress Rate=(Amount of Completed Work/Amount of Entire Work)×100(%)

Planned Progress Rate=(Amount of Planned Completed Work/Amount of Entire Work)×100(%)

The amount of the entire work is an amount of the entire work for a group of tasks associated with a given system configuration CI. The amount of completed work is an amount of work completed at a given time. The amount of planned completed work is an amount of work planned to be completed at a given time.

When the attribute of each task has a phase attribute or a responsible person attribute, the progress rate may be calculated after the amount of work is filtered using the phase or the responsible person. The computer system can differently display the filtered system configuration CIs and the unfiltered system configuration CIs by translucently displaying the filtered system configuration CIs.

The display allows the administrator to grasp the progress state of tasks associated with the system configuration CIs having the dependency at a glance.

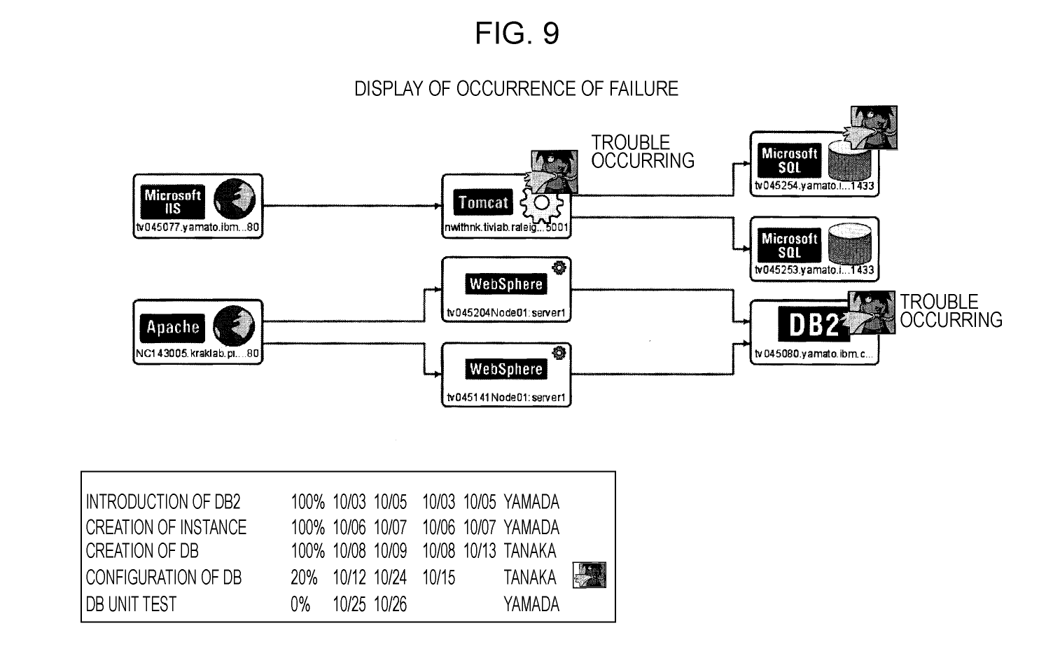

FIG. 9 shows an example of display of occurrence of a trouble according to an embodiment of the present invention. The task data mapping module (507 of FIG. 5) acquires task information regularly or at predetermined intervals. Occurrence of a trouble is acquired based on data of trouble occurring attribute of the task data or the task CI. The computer system displays a trouble occurring icon above the system configuration CI associated with the task where the trouble occurs.

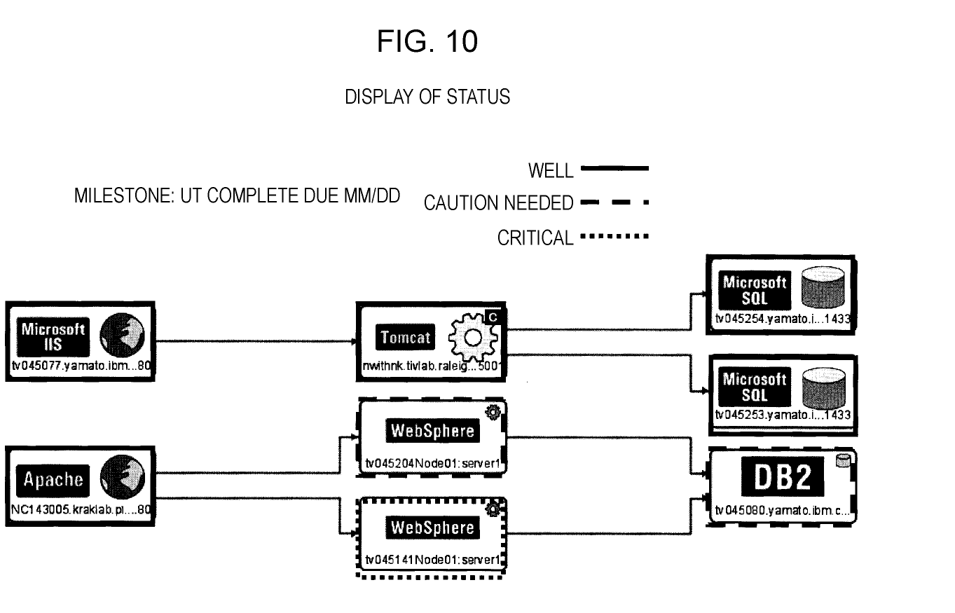

FIG. 10 shows an example of display of a status of a task associated with the system configuration CIs according to an embodiment of the present invention. A milestone of a project is set in association with a phase of a task. The milestone may be, for example, “unit test (UT) completion due: MMDD, integration test completion due: MMDD”. The status is defined by a progress state relative to the milestone. The progress state of a group of tasks associated with respective system configuration CI with respect to a planned date set by the milestone is displayed as the status.

In one embodiment, if the status is on schedule or ahead of schedule, a term “well” may be displayed or an icon or a figure indicating “well” is displayed. In FIG. 10, an outer frame of the system configuration CI whose progress is in “the well state” with respect to the milestone is enclosed by a solid line. If the status indicates a delay less than a week, a term “caution needed” may be displayed or an icon or a figure indicating “caution needed” may be displayed. In FIG. 10, an outer frame of the system configuration CI whose progress is in “the caution needed state” is enclosed by a wavy line. If the status indicates a delay not less than a week, a term “critical” may be displayed or an icon or a figure indicating “critical” may be displayed. In FIG. 10, an outer frame of the system configuration CI whose progress is in “the critical state” is enclosed by a broken line.

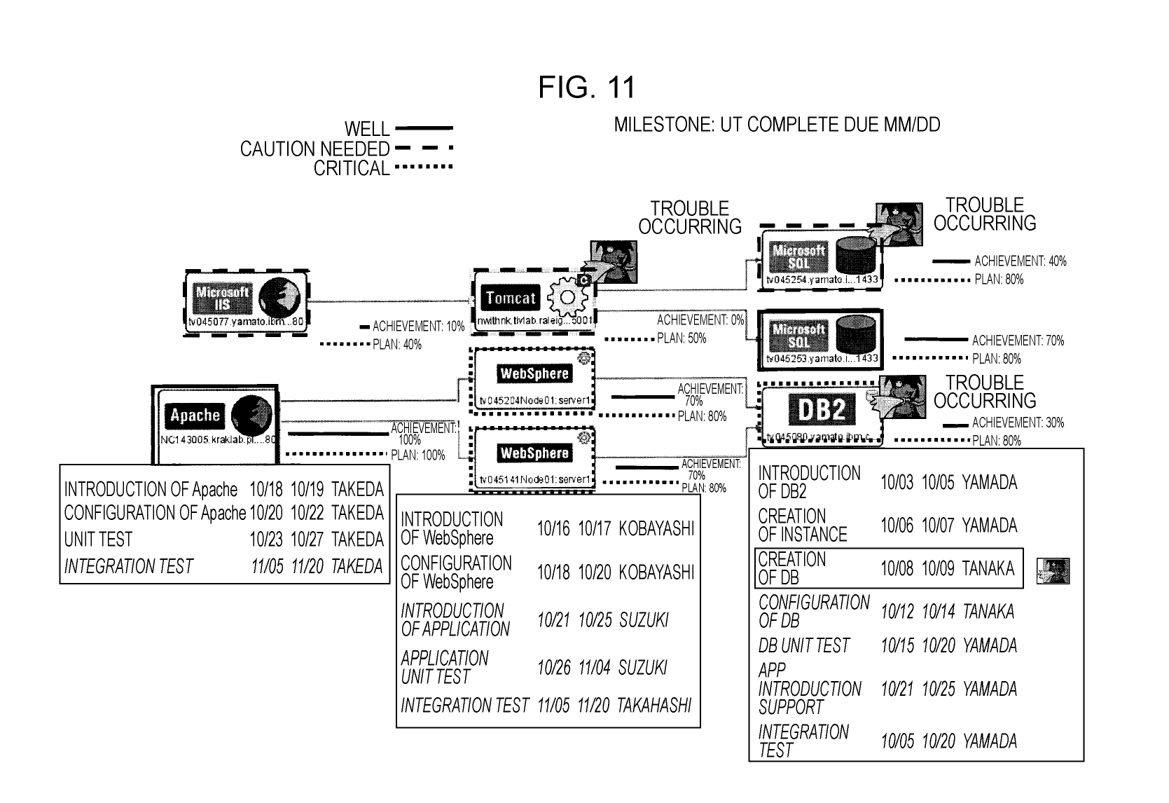

FIG. 11 shows an example of display of information regarding the system configuration CIs and tasks according to an embodiment of the present invention. The display includes display of the progress rate, display of the occurrence of a trouble, and display of the status at the same time.

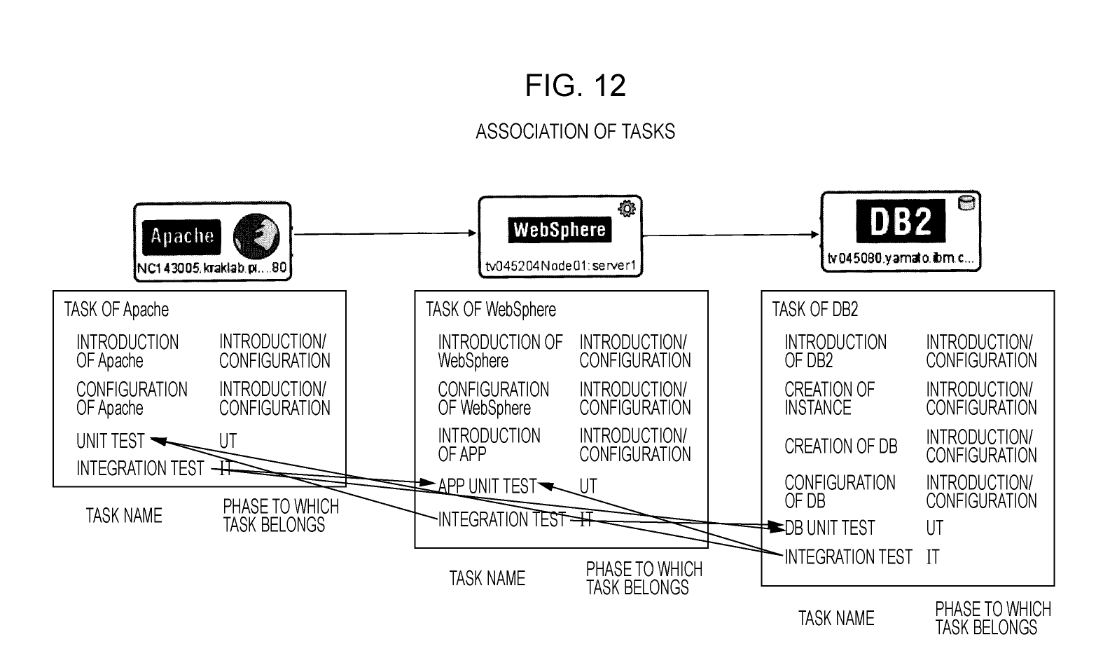

FIG. 12 shows an example of display of an association between a task and another task according an embodiment of the present invention. FIG. 12 also shows an embodiment of the system configuration CIs of Apache, WebSphere, and DB2 and information regarding tasks associated with the system configuration CIs. Information regarding the tasks indicates a task name and a phase to which the task belong. Tasks of Apache may include “introduction of Apache”, “configuration of Apache”, “unit test”, and “integration test”. Tasks of WebSphere include “introduction of WebSphere”, “configuration of WebSphere”, “introduction of application”, “application unit test”, and “integration test”. Phases of the tasks of Apache are the introduction/configuration of Apache, the UT (unit test), and the IT (integration test). Tasks of DB2 includes “introduction of DB2”, “creation of instance”, “creation of DB”, “configuration of DB”, “DB unit test”, and “integration test”. The phase to which each task belongs is one of “introduction/configuration”, “UT”, and “IT”.

In FIG. 12, an association between tasks is shown by an arrow. In FIG. 12, it is known from the arrow that completion of all of unit tests may be a prerequisite of the integration of the task of Apache. Accordingly, in FIG. 12, completion of other tasks associated with the task of Apache, namely, completion of the unit tests of the task of WebSphere and the task of DB2, may be a prerequisite of the integration test of Apache.

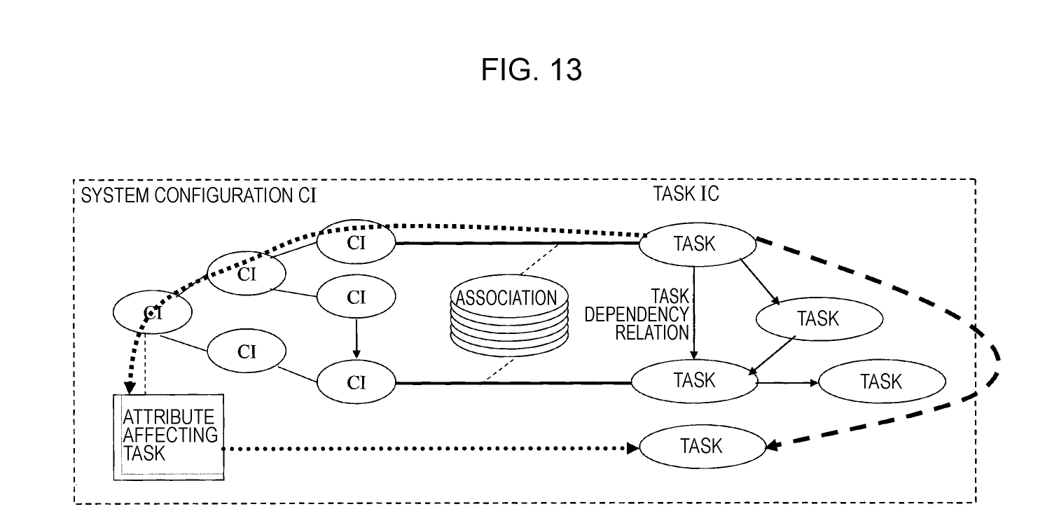

FIG. 13 shows automatic detection of a relation between tasks according to an embodiment of the present invention. The detection is performed using data of the attribute and relations of the system configuration CIs. To permit the detection, the following attributes may be set regarding the system configuration CIs or tasks associated with CIs relating to the system configuration CIs: an attribute regarding whether a restriction for the task exists; an attribute regarding whether a preceding task exists; and an attribute regarding whether a following task exists. If the attribute regarding whether a restriction for the task exists indicates the existence of the restriction, works for the system configuration CIs cannot be performed at the same time. In addition, if the attribute regarding whether the preceding or following task exists indicates the existence of the preceding or following task, there is a task depending on the task associated with the system configuration CI.

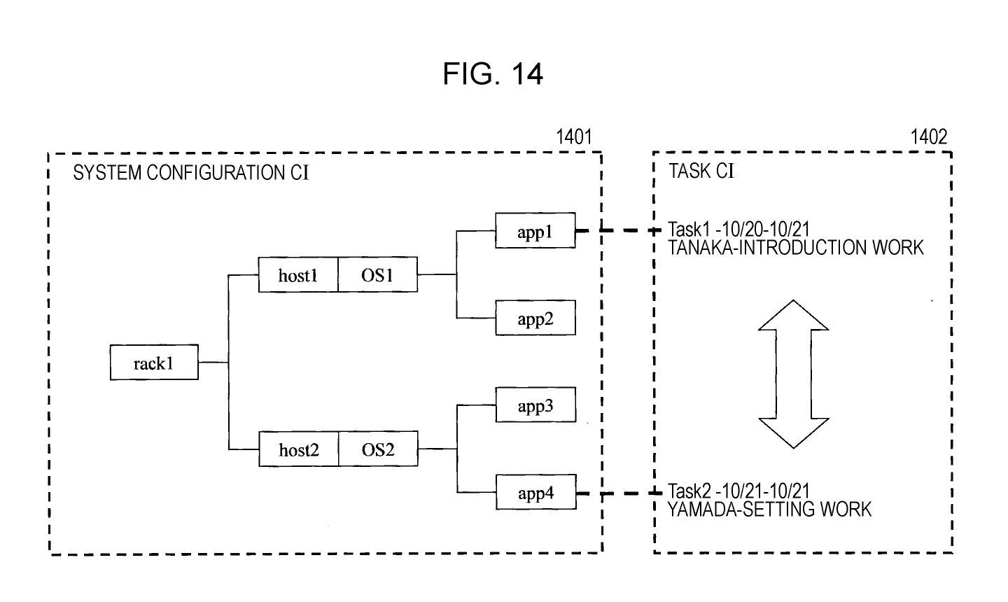

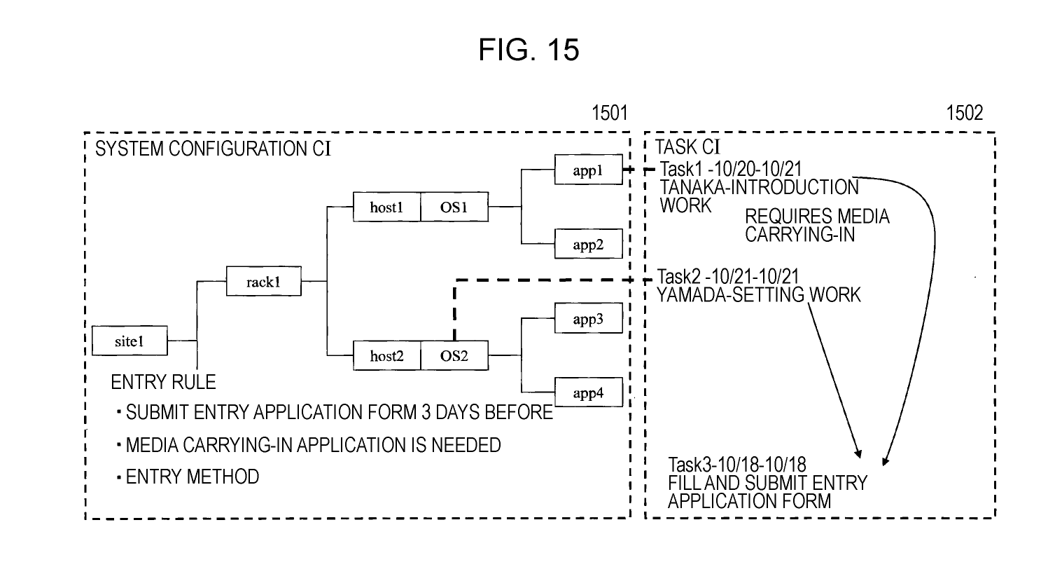

By detecting the relation between the tasks, the conflict between tasks (see FIG. 14) and the preceding task (see FIG. 15) may be detected. Through this detection, the relation between the tasks can be automatically detected according to the updated progress state.

FIG. 14 shows detection of a conflict between tasks according to an embodiment of the present invention. A plurality of system configuration CIs (1401) is shown in a system configuration diagram of a relation of physical positions. The system has one rack (rack1). The rack has an attribute “equipped with one console”. The console corresponds to a set of a display, a keyboard, and a mouse. The rack (rack1) includes two server computers (host1 and host2). An operating system (OS1) operates in the server computer host1. Applications (app1 and app2) operate on the OS1. Similarly, an operating system OS2 operates in the server computer host2. Applications (app3 and app4) operate on the OS2.

In one embodiment of the invention, there are two task CIs Task1 and Task2. The system configuration CI app1 is associated with the task CI (Task1). Similarly, the system configuration CI app4 is associated with the task CI (Task2). A schedule attribute of the Task1 is October 20-October 21, whereas a schedule attribute of the Task2 is October 21-October 21. Accordingly, each schedule of the Task1 and Task2 uses the rack (rack1) on the same day. However, since the rack has the attribute of “equipped with one console”, a plurality of tasks using the same rack (rack1) on the same day conflict. Accordingly, the task CIs (Task1 and Task2) associated with the physical position of the same rack (rack1) may be filtered by the schedule. This may allow the computer system to automatically detect the conflict between the tasks.

In addition, the computer system may update the task data regularly or at predetermined intervals. The import unit (407 of FIG. 4) acquires data regarding tasks from the WBS (402 of FIG. 4) and stores the data in the repository (403 of FIG. 4). Alternatively, the discovery unit (101 of FIG. 1A) acquires data regarding tasks from the WBS (402) and stores the data in the CMDB (105 of FIG. 1A) as task CI instances (416 of FIG. 4). Accordingly, the computer system can automatically detect the conflict between the tasks even if a conflict between new tasks occurs after the system development progresses and a delay of the task or creation of a new task is caused.

FIG. 15 shows detection of a preceding task according to an embodiment of the present invention. A plurality of system configuration CIs (1501) is shown in a system configuration diagram of a relation of physical positions. An attribute of a system configuration CI (site1) has entry rules. The entry rules are that an entry application form has to be submitted three days before, a media carrying-in application is needed at the time of entry, and an entry method is specified. Regarding task CIs (1502), there are two task CIs Task1 and Task2. A system configuration CI (app1) is associated with the task CI (Task1). Similarly, a system configuration CI (OS2) is associated with the task CI (Task2). The Task1 has a flag of “requiring carrying-in of media”.

Here, the computer system retrieves the task CIs stored in the CMDB that enters the site1 on October 21 in the CMDB. Furthermore, the computer system filters the tasks physically associated with the system configuration CI (site1) by the schedule. As a result of filtering, the computer system may schedule a task for filling the application for entering the site1 on October 21 and assigns the task to each responsible person of the task CIs (Task1 and Task2). Furthermore, the computer system may schedule a Task3 for filling a media carrying-in application form on October 18 for the Task2 and assigns the Task3. In this manner, the computer system can detect the preceding task.

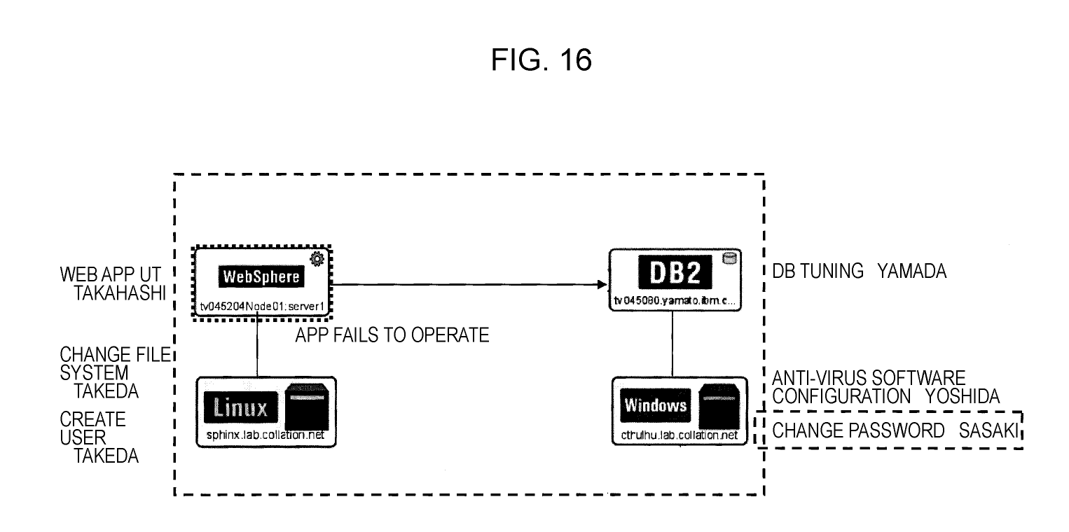

FIG. 16 shows detection of tasks involving a change in a system according to an embodiment of the present invention. An administrator attempts to detect a task that causing a trouble in an application (WebSphere) that was operating last week. The WBS manages the task information, e.g., the progress history, as a work history. The task data mapping module (507 of FIG. 5) may regularly import the progress status from the WBS (502 of FIG. 5) and updates the task data or the task CI stored in the repository (503). The computer system detects a task whose work progress is changed after a date when the application was operating among tasks associated with the configuration items associated with the application (WebSphere). The computer system displays the detected task near the system configuration CI associated with the task. The display allows the administrator to understand that the cause of the trouble of the application (WebSphere) is the password change in the system configuration CI (Windows). As described above, the computer system can extract and display the associated task from the work history when the system configuration CI is changed at the time of trouble.

Although the detection has been described for an example of a change in the system, in another embodiment, the detection may be applied to a change in the design specification.

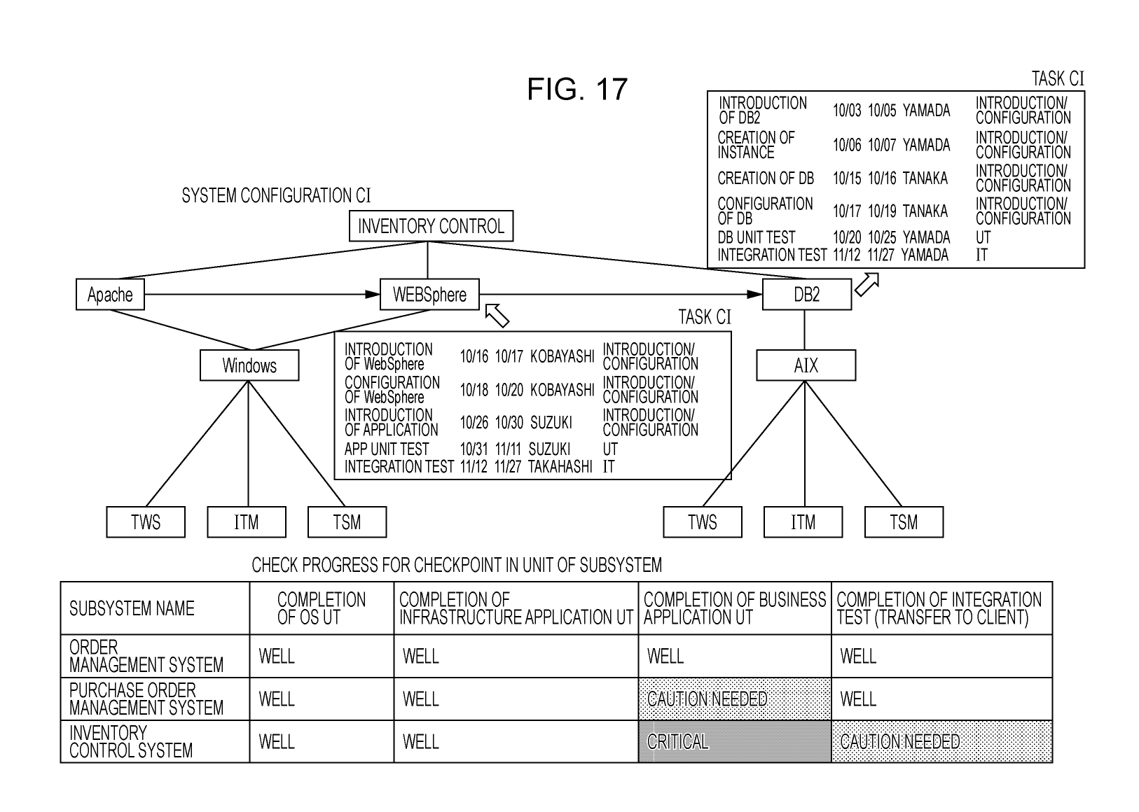

FIG. 17 shows processing of task information using information regarding system configuration CIs according to an embodiment of the present invention. FIG. 17 shows that a store management system has an order management system, a purchase order management system, and an inventory control system as subsystems. The order management system has the relation shown in FIG. 17 with respective system configuration CIs. The system configuration CIs are displayed in association with the task CIs. The computer system checks the progress state of the task in a unit of subsystem and may display one of “well”, “caution needed”, and “critical”.

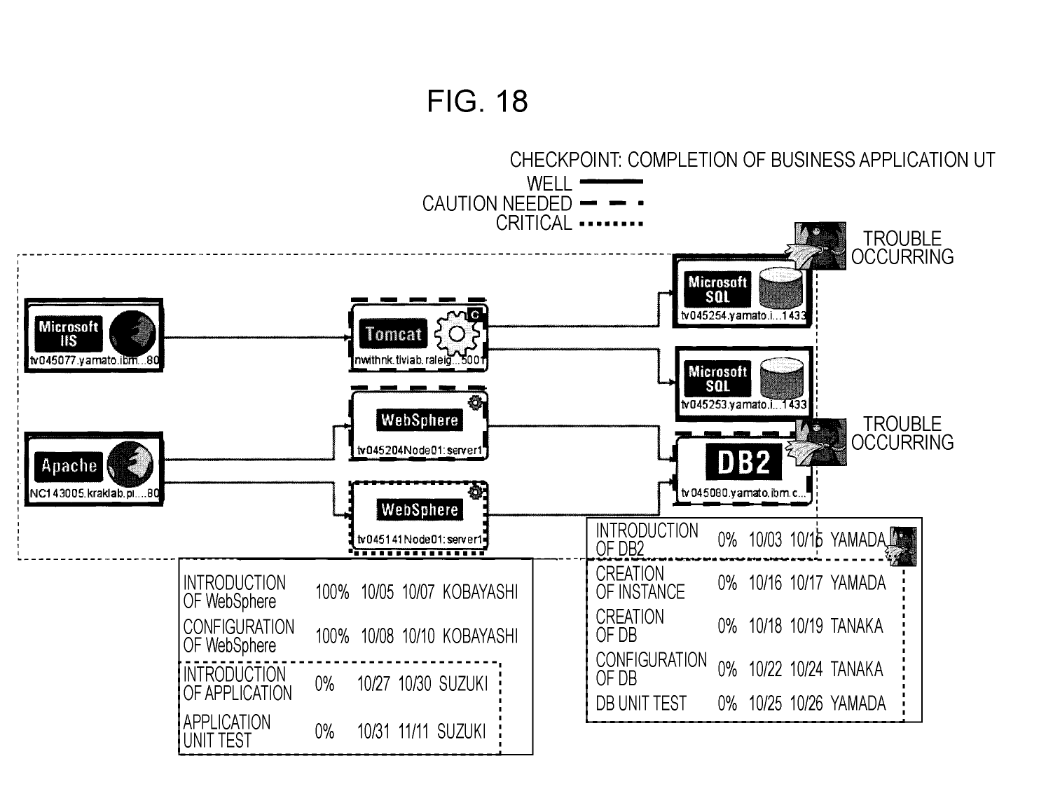

FIG. 18 shows display of a more detailed progress state from display of a progress state in a unit of subsystem of FIG. 17. FIG. 18 shows a diagram showing a task list of subsystem configuration CIs. FIG. 18 may include checkpoints, display of occurrence of a trouble, and display of a progress state of each task CI at the same time. The display of the progress state of the task CI includes a task name, an actual progress rate, a scheduled completion date, a completion date, and a name of a responsible person. In addition, in the display of the progress state of the task CI, a task that has to be advanced rapidly after recovery from the trouble is enclosed by a wavy line. Based on the display, the administrator can grasp unachieved tasks and can easily grasp the tasks to be advanced rapidly after the recovery from the trouble.

Embodiments of the invention have been described with reference to flowchart illustrations and/or block diagrams of methods, computer systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

A computer used in the computer system of the embodiment includes a CPU and a main memory, which are connected to a bus. Preferably, the CPU is based on 32-bit or 64-bit architecture. For example, the Xeon (trademark) series, the Core (trademark) series, the Pentiun (trademark) series, the Celeron (trademark) series of Intel Corporation and the Phenom (trademark) series and the Athlon series of AMD Inc. can be used. A display, such as an LCD monitor, is connected to the bus through a display controller. The display is used for displaying information regarding a computer connected to a network via a communication line and information regarding software operating in the computer as an appropriate graphical interface for the purpose of management of the computer system. A hard disk or a silicon disk and a CD-ROM drive or a DVD drive are connected to the bus through an IDE or SATA controller.

The hard disk stores an operating system, a program for providing a Java processing environment such as J2EE, an operation/management program for CMDB, other programs, and data in a manner that the programs and data can be loaded to the main memory. Preferably, the operation/management program includes TADDM (Tivoli (trademark) Application Dependency Discovery Manager) provided by IBM. A CD-ROM, DVD, or BD drive is used to additionally introduce programs to the hard disk from a CD-ROM, a DVD-ROM, or a BD. A keyboard and a mouse are connected to the bus through a keyboard/mouse controller.

A communication interface is compliant with, for example, an Ethernet protocol and is connected to the bus through a communication controller. The communication interface physically connects the computer to the communication line and provides a network interface layer for the TCP/IP communication protocol of the communication function of the operating system of the computer. Meanwhile, the communication line may be a wired LAN environment or a wireless LAN environment based on wireless LAN connection specifications, such as, for example, IEEE 801.11a/b/g/n.

A network switch, router and a hardware management console may be used as a network connection device for connecting hardware, such as the computer. That is, those devices has a function of returning configuration information, such as an IP address and a MAC address, of the computer connected thereto in response to an inquiry using a predetermined command from a computer to which a network operation/management program is introduced. The network switch and router have an ARP table including a list of a pair of an IP address of a computer connected thereto and a MAC address corresponding to the IP address for use in the address resolution protocol (ARP) and has a function of returning a content of the ARP table in response to an inquiry using the predetermined command. The hardware management console can return more detailed configuration information of the computer than the ARP table.

Although the present invention has been described based on the embodiments in the above, the contents described in the embodiments are an example of the present invention. It is obvious that various modifications may occur to those skilled in the art without departing from the technical scope of the present invention. For example, a database of another format and other CIs can be used instead of a CMDB and CIs stored therein. Additionally, a given computer development environment that can call APIs having a network management function, such as C++ and C#, can be used in addition to Java.

1. A computer system for managing progress of tasks, the computer system comprising:
a processor; and
a computer readable storage medium included in the processor;
wherein the computer readable storage medium has disposed within it:
a repository for holding one or more data sets representative of at least one predetermined attribute of a configuration item and a relation between the configuration item and another configuration item; and
a discovery unit for detecting data associated with the configuration item,
wherein one or more of the configuration items are included in a system defined by a digital design specification.

2. The computer system of claim 1, wherein the repository further holds one or more data sets representative of the tasks and association data for associating the configuration item and at least one task.

3. The computer system of claim 1, wherein the one or more data sets are created from data in the system defined by the digital design specification.

4. The computer system of claim 2, wherein the one or more data sets and the association data are updated using the detected data.

5. The computer system of claim 1, wherein the system defined by the digital design specification is either under development or maintenance and the one or more tasks are related to the development or the maintenance.

6. The computer system of claim 1, further comprising a display device for displaying a topology map that indicates information regarding at least one configuration item included in the system defined by the digital design specification, the relation between the configuration item and another configuration item, and the one or more tasks associated with the configuration item.

7. The computer system of claim 6, wherein the display device displays updated information regarding the configuration item in response to a change in at least one configuration item or in response to a change in the data representative of the configuration item.

8. The computer system of claim 6, wherein the data set representative of the one or more tasks is updated using imported data regarding the one or more tasks.

9. The computer system of claim 6, wherein the data set representative of the one or more tasks corresponds to at least one of information regarding a task progress rate or a task progress state, an amount of remaining work of the task, a task list, and an association between one task and another task.

10. The computer system of claim 2, wherein the attribute of the association data corresponds to at least one of a name of a host related to the task, a name of an application, and a port number of the application.

11. The computer system of claim 1, wherein the configuration item corresponds to one of a computer, a computer peripheral device, application software, a digital appliance, and an existent configuration item associated with the configuration item included in the system defined by the digital design specification.

12. The computer system of claim 2, further comprising an association data creating unit for mapping the data set representative of the configuration item and the data set representative of the task to create the association data.

13. A method for managing progress of tasks comprising:
collecting, in a repository, one or more data sets representative of at least one predetermined attribute of a configuration item and a relation between the configuration item and another configuration item;
holding one or more data sets representative of one or more tasks in the repository;
storing association data for associating the configuration item and at least one task in the repository; and
detecting data regarding the configuration item, wherein at least one of the data sets and the association data being updated using the detected data.

14. The method of claim 13, wherein one or more of the configuration items are included in a system defined by a digital design specification.

15. The method of claim 14, wherein the system defined by the digital design specification is either under development or maintenance and the one or more tasks are related to the development or the maintenance.

16. The method of claim 13, further comprising detecting a relation between the tasks using the association data of the configuration items.

17. The method of claim 16, further comprising scheduling a new task in response to detection of the relation between the tasks.

18. The method of claim 13, further comprising displaying, in a display device, a topology map that indicates information regarding at least one configuration item included in the system defined by the digital design specification, the relation between the configuration item and another configuration item, and the one or more tasks associated with the configuration item.

19. The method of claim 13, further comprising mapping the data set representative of the configuration item and the data set representative of the task to create the association data.

20. A computer program product for managing progress of tasks comprising:
a computer-usable medium including:
computer program instructions for collecting, in a repository, one or more data sets representative of at least one predetermined attribute of a configuration item and a relation between the configuration item and another configuration item;
computer program instructions for holding one or more data sets representative of one or more tasks in the repository;
computer program instructions for storing association data for associating the configuration item and at least one task in the repository; and
computer program instructions for detecting data regarding the configuration item wherein at least one of the data sets and the association data being updated using the detected data,
wherein one or more of the configuration items are included in a system defined by a digital design specification.
